(19) United States
(12) Patent Application Publication
(10) Pub. No.: US 2010/0010148 A1
(43) Pub. Date: Jan. 14, 2010

(54) AQUEOUS PIGMENT DISPERSION, METHOD FOR PRODUCING THE SAME, AND RECORDING LIQUID CONTAINING THE SAME

(75) Inventors: Shinichiro Imai, Kanagawa (JP); Masanobu Yokoyama, Fukuoka (JP); Takahiro Saito, Kanagawa (JP); Mayuko Takasu, Fukuoka (JP); Rie Nishida, Kanagawa (JP); Terutoshi Sato, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical Corporation, Minato-ku (JP)

(21) Appl. No.: 12/524,726

(22) PCT Filed: Feb. 18, 2008
(86) PCT No.: PCT/JP08/52648

§ 371 Date: Jul. 28, 2009

(30) Foreign Application Priority Data
Feb. 26, 2007 (JP) 2007-045773

(51) Int. Cl. C09D 11/10; C08L 33/02

(52) U.S. Cl. 524/522

(57) ABSTRACT

Disclosed is a recording liquid including an aqueous pigment dispersion, which has high dispersion stability and high discharge properties and gives a print with superior gloss. Specifically, the aqueous pigment dispersion contains a pigment; a polymer containing cationic monomer structural units and hydrophobic monomer structural units (hydrophobic-group-containing cationic polymer); and a polymer containing anionic monomer structural units and hydrophobic monomer structural units (hydrophobic-group-containing anionic polymer), in which the ratio of the number of anionic groups in the hydrophobic-group-containing anionic polymer to the number of cationic groups in the hydrophobic-group-containing cationic polymer is 1.0 or more and 8 or less. The molar ratio of the hydrophobic monomer structural units to the anionic monomer structural units in the hydrophobic-group-containing anionic polymer is from 5/95 to 50/50 or the content of the pigment is 51 percent by weight or more based on the solids content. This aqueous pigment dispersion is produced by dispersing a pigment with a hydrophobic-group-containing cationic polymer, subsequently subjecting the dispersion to ultrafiltration/microfiltration, and adding a hydrophobic-group-containing anionic polymer thereto.

### FIELD OF THE INVENTION

The present invention relates to an aqueous pigment dispersion containing a pigment, a hydrophobic-group-containing cationic polymer, and a hydrophobic-group-containing anionic polymer, and to a method for producing the aqueous pigment dispersion. It also relates to a recording liquid which contains the aqueous pigment dispersion and is suitable especially for recording with an ink-jet printer.

### BACKGROUND OF THE INVENTION

Ink-jet printers are rapidly propagating from both personal use and business use for such reasons that full colorization can be easily achieved; that noises are low; that an image with high resolution is obtained at low costs; and that high-speed printing is possible. At present, as a recording liquid to be used for inkjet printers, aqueous recording liquids are the mainstream, and prints with high resolution become available.

As the aqueous recording liquids, one containing a water-soluble dye and a liquid medium as the major components was the mainstream. However, prints obtained by such an aqueous recording liquid were insufficient with respect typically to water fastness, light fastness, and ozone fastness, because the aqueous recording liquid contains a water-soluble dye. In recent years, therefore, an aqueous recording liquid of a pigment dispersion type (pigment-dispersed aqueous recording liquid) in which a pigment is dispersed in an aqueous medium (hereinafter also referred to simply as “ink”) is developed in place of such a dye.

In recent years, following the enhancement of resolution of prints, the amount of the ink to be discharged from an ink discharge nozzle per single discharge is more and more reduced. Additionally, as ink-jet printers should work at a higher and higher printing speed, such pigment-dispersed aqueous recording liquids are required to have higher pigment dispersion stability, higher discharge properties from a printer head, high rub fastness or scratch resistance of prints, and a high gloss, if discharged, on an ink-jet recording paper. To meet these requirements, there have been proposed pigment-dispersed aqueous recording liquids using a polymer containing cationic groups and another polymer containing anionic groups in combination.

Typically, Patent Document 1 describes an ink-jet composition containing water, a coloring agent, a water-soluble anionic copolymer, and a water-soluble cationic copolymer.

Patent Document 2 describes a polymer emulsion composition containing emulsion particles of a water-insoluble polymer A; and a water-soluble polymer B, in which the water-insoluble polymer A has an ionic group and the emulsion particles thereof may contain a coloring material, and the water-soluble polymer B contains an ionic group having an ionicity differing from that of the ionic group of the water-insoluble polymer A.

Patent Documents 3 and 4 each describe an aqueous pigment dispersion for use in recording, which contains an organic acrylic polymer compound having cationic groups in its side chain; an organic acrylic polymer compound having anionic groups in its side chain; and a pigment.

Patent Document 5 describes an encapsulated pigment dispersion which includes a pigment encapsulated by a polymer, in which the polymer is a polymerized product of an ionic-group-containing polymer A, a reactive emulsifier having an opposite charge to the charge of the polymer A, and a monomer.

Patent Document 1: Japanese Unexamined Patent Application Publication No. 6-240191 (Dainippon Ink & Chemicals, Inc.)

Patent Document 2: Japanese Unexamined Patent Application Publication No. 2003-313430 (Kao Corporation)

Patent Document 3: Japanese Unexamined Patent Application Publication No. 2004-59625 (DIC Corporation)

Patent Document 4: Japanese Unexamined Patent Application Publication No. 2004-75820 (DIC Corporation)

Patent Document 5: PCT International Publication Number WO 2006/137393 (Seiko Epson Corporation and Mitsubishi Chemical Corporation)

The technique in Patent Document 1 proposes the combination use of a water-soluble anionic copolymer and a water-soluble cationic copolymer for imparting water fastness to dyes and pigments. This combination use, however, is merely expected to make an ink composition insoluble to thereby impart water fastness thereto, and the resulting ink composition is inferior in dispersion stability and discharge properties. To improve these dispersion stability and discharge properties, it is recommended in the document that the ink composition has a pH of 11 or more. This pH range is, however, not realistic from the viewpoints of safety to the human body or maintenance of the printer body.

The technique in Patent Document 2 uses the water-soluble polymer B having the opposite charge to the charge of the water-insoluble polymer A in order to ensure the storage stability of emulsion particles of the polymer A which may contain a coloring material. However, even if such a water-soluble polymer is merely used, the dispersion stability thereof is likely to decrease due typically to heating, the presence of a solvent, or a pH change. Additionally, as the polymer A is insoluble in water and has a small quantity of charge, the amount of the polymer B to be adsorbed on the emulsion particles of the polymer A is limited. Thus, the dispersion stability is likely to decrease because of a shortage of the amount of the polymer B covering the emulsion particles, and/or the viscosity is likely to increase because of an excess of the polymer B that is not adsorbed on the emulsion particles.

The technique in Patent Document 3 is proposed in order to effectively suppress gelation and thickening (viscosity increase) and to give a dispersion that has a low viscosity and excels in dispersibility and dispersion stability, which gelation and thickening often occur in the production of a pigment dispersion containing two or more polymeric compounds differing in polarity or one containing an amphoteric polymeric compound. Specifically, the technique proposes a dispersion including a pigment and a polymer mixture both dispersed in an aqueous medium, which polymer mixture contains an organic acrylic polymer compound having cationic groups in its side chain and another organic acrylic polymer compound having anionic groups in its side chain. In this formulation, however, the polymer forms a firm complex, is very likely to aggregate, is thereby unlikely to be adsorbed on the surface of the pigment, and insufficiently works to disperse the pigment. This makes the pigment particles difficult to have smaller diameters and makes the pigment particles to be covered completely by the polymer.

To obtain effects as with above, the technique in Patent Document 4 also proposes a dispersion which includes an acidic pigment; a cationic polymer covering the acidic pigment; and an anionic polymer covering the cationic polymer. However, the pigment has been subjected to surface treatment and thereby has functional groups that are ununiformly distributed in a limited number on its surface. It is therefore difficult for the cationic polymer to cover the pigment uniformly, resulting in mere decrease in the quantity of charge on the surface of the pigment. As a result, the dispersion stability and discharge properties decrease, and ununiform covering of the surface of pigment often causes, for example, decrease in gloss, if printed, on a photo paper.

The technique in Patent Document 5 proposes an encapsulated pigment dispersion which is prepared by dispersing a pigment with an ionic-group-containing polymer to give a pigment dispersion; allowing the pigment dispersion to adsorb a reactive emulsifier having an ionic group with the ionicity opposite to that of the ionic-group-containing polymer; introducing a monomer thereinto; and polymerizing the monomer and the reactive emulsifier to thereby encapsulate the pigment therein. However, since the monomer is introduced by using the reactive emulsifier, it is difficult to thoroughly suppress the occurrence of polymer microparticles which do not contain the pigment, and the resulting dispersion has an increased viscosity. Additionally, it is difficult to remove residual monomers completely, and such residual monomers cause problems in safety.

Accordingly, an object of the present invention is to provide an aqueous pigment-dispersed recording liquid which gives through printing a print having higher dispersion stability and higher discharge properties and excelling in gloss and which is superior especially as an ink-jet recording liquid. Another object of the present invention is to provide an aqueous pigment dispersion for use in the ink-jet recording liquid and a method for producing the aqueous pigment dispersion.

### SUMMARY OF THE INVENTION

To achieve these objects, the present inventors made intensive investigations on aqueous pigment-dispersed recording liquids. As a result, they have found that not only good dispersion stability of a pigment is obtained but also a recording liquid using the dispersion has good discharge properties, and, additionally, the resulting print has a superior gloss in an aqueous pigment dispersion including the pigment, a polymer containing cationic monomer structural units and hydrophobic monomer structural units (hereinafter referred to as “hydrophobic-group-containing cationic polymer”), and a polymer containing anionic monomer structural units and hydrophobic monomer structural units (hereinafter referred to as “hydrophobic-group-containing anionic polymer”), by setting the ratio of the number of anionic groups contained in the hydrophobic-group-containing anionic polymer to the number of cationic groups contained in the hydrophobic-group-containing cationic polymer being 1.0 or more and 8 or less, and setting the molar ratio of the hydrophobic monomer structural units to the anionic monomer structural units in the hydrophobic-group-containing anionic polymer being from 5/95 to 50/50.

They have also found that not only good dispersion stability of a pigment is obtained but also a recording liquid using the dispersion has good discharge properties, and, additionally, the resulting print has a superior gloss in an aqueous pigment dispersion including the pigment, a polymer containing cationic monomer structural units and hydrophobic monomer structural units (hereinafter referred to as “hydrophobic-group-containing cationic polymer”), and a polymer containing anionic monomer structural units and hydrophobic monomer structural units (hereinafter referred to as “hydrophobic-group-containing anionic polymer”), by setting the ratio of the number of anionic groups contained in the hydrophobic-group-containing anionic polymer to the number of cationic groups contained in the hydrophobic-group-containing cationic polymer being 1.0 or more and 8 or less, and setting the content of the pigment being 55 percent by weight or more based on the solids content of the aqueous pigment dispersion.

Additionally, they have found that the aqueous pigment dispersion can be stably produced by dispersing a pigment by the action of a hydrophobic-group-containing cationic polymer; subsequently carrying out ultrafiltration/microfiltration; and further adding a hydrophobic-group-containing anionic polymer thereto.

The present invention has been made based on these findings.

### First Embodiment

An aqueous pigment dispersion which includes a pigment; a polymer containing structural units of a cationic monomer and structural units of a hydrophobic monomer (hereinafter referred to as “hydrophobic-group-containing cationic polymer”); and a polymer containing structural units of an anionic monomer and structural units of a hydrophobic monomer (hereinafter referred to as “hydrophobic-group-containing anionic polymer), in which the ratio of the number of anionic groups contained in the hydrophobic-group-containing anionic polymer to the number of cationic groups contained in the hydrophobic-group-containing cationic polymer is 1.0 or more and 8 or less, and the hydrophobic-group-containing anionic polymer has a molar ratio of the hydrophobic monomer structural units to the anionic monomer structural units being from 5/95 to 50/50.

### Second Embodiment

An aqueous pigment dispersion which includes a pigment; a polymer containing structural units of a cationic monomer and structural units of a hydrophobic monomer (hereinafter referred to as “hydrophobic-group-containing cationic polymer”); and a polymer containing structural units of an anionic monomer and structural units of a hydrophobic monomer (hereinafter referred to as “hydrophobic-group-containing anionic polymer”), in which the ratio of the number of anionic groups contained in the hydrophobic-group-containing anionic polymer to the number of cationic groups contained in the hydrophobic-group-containing cationic polymer is 1.0 or more and 8 or less, and the content of the pigment is 51 percent by weight or more based on the solids content of the aqueous pigment dispersion.

### Third Embodiment

The aqueous pigment dispersion according to First or Second Embodiment, which has a pH being 7 or more and 9 or less.

### Fourth Embodiment

The aqueous pigment dispersion according to any one of First to Third Embodiments, in which the pigment, if existing alone, does not disperse in water.

### Fifth Embodiment

The aqueous pigment dispersion according to any one of First to Fourth Embodiments, in which the hydrophobic-group-containing cationic polymer has a molar ratio of the hydrophobic monomer structural units to the cationic monomer structural units being from 40/60 to 90/10.

### Sixth Embodiment

The aqueous pigment dispersion according to any one of First to Fifth Embodiments, in which at least one of hydrophobic monomer structural units in the hydrophobic-group-containing cationic polymer is a structural unit derived from an aromatic hydrocarbon.

### Seventh Embodiment

The aqueous pigment dispersion according to any one of First to Sixth Embodiments, in which at least one of hydrophobic monomer structural units in the hydrophobic-group-containing cationic polymer is a structural unit derived from an aliphatic hydrocarbon having 4 or more and 12 or less carbon atoms.

### Eighth Embodiment

The aqueous pigment dispersion according to any one of First to Seventh Embodiments, in which the cationic monomer structural units in the hydrophobic-group-containing cationic polymer include a structure of a quaternary ammonium salt.

### Ninth Embodiment

The aqueous pigment dispersion according to any one of First to Eighth Embodiments, in which the hydrophobic-group-containing cationic polymer has a number-average molecular weight being 500 or more and 50000 or less.

### Tenth Embodiment

The aqueous pigment dispersion according to any one of First to Ninth Embodiments, in which the hydrophobic monomer structural units in the hydrophobic-group-containing anionic polymer include one or more structural units selected from the group consisting of structural units derived from aromatic hydrocarbons and structural units derived from alicyclic hydrocarbons.

### Eleventh Embodiment

The aqueous pigment dispersion according to any one of First to Tenth Embodiments, in which the anionic monomer structural units in the hydrophobic-group-containing anionic polymer contain one or more structures selected from the group consisting of a carboxylic acid, an alkali metal salt of a carboxylic acid, and an alkaline earth metal salt of a carboxylic acid.

### Twelfth Embodiment

The aqueous pigment dispersion according to Eleventh Embodiment, in which the carboxylic acid and/or a salt thereof contained in the anionic monomer structural unit in the hydrophobic-group-containing anionic polymer is a carboxylic acid selected from the group consisting of acrylic acid, methacrylic acid, itaconic acid, maleic acid, and fumaric acid; and/or a salt of the carboxylic acid.

### Thirteenth Embodiment

The aqueous pigment dispersion according to any one of First to Twelfth Embodiments, in which the hydrophobic-group-containing anionic polymer has a number-average molecular weight being 2000 or more and 50000 or less.

### Fourteenth Embodiment

The aqueous pigment dispersion according to any one of First to Thirteenth Embodiments, in which the hydrophobic-group-containing anionic polymer further contains structural units a nonionic hydrophilic monomer in addition to the hydrophobic monomer structural units and anionic monomer structural units.

### Fifteenth Embodiment

A method for producing the aqueous pigment dispersion of any one of First to Fourteenth Embodiments, the method includes the steps of dispersing a pigment by the action of a hydrophobic-group-containing cationic polymer; removing an excess of the polymer from the dispersion through ultrafiltration and/or microfiltration; and subsequently adding a hydrophobic-group-containing anionic polymer.

### Sixteenth Embodiment

A recording liquid which contains the aqueous pigment dispersion of any one of First to Fourteenth Embodiments.

### Seventeenth Embodiment

An ink-jet recording liquid which contains the aqueous pigment dispersion of any one of First to Fourteenth Embodiments.

According to the present invention, it is possible to provide a pigment-dispersed recording liquid which can give a print being superior in gloss, high in optical density, being suppressed in blur, having high printing quality, and showing good fastness such as rub fastness, light fastness, and water fastness and which has a low viscosity, good discharge properties, and good storage stability. In particular, the recording liquid according to the present invention can be suitably used as a recording liquid typically for an ink-jet printer.

### DETAILED DESCRIPTION OF THE INVENTION

Certain embodiments of the present invention will be illustrated in detail below. It should be noted, however, the following description regarding components is merely illustrated as an example (representative example) of embodiments of the present invention, the contents of which are never construed to limit the scope of the present invention, without departing from the spirit and scope thereof.

### 1. Aqueous Pigment Dispersion

The aqueous pigment dispersion according to the present invention contains, in an aqueous medium, at least a pigment, a hydrophobic-group-containing cationic polymer, and a hydrophobic-group-containing anionic polymer, in which the ratio of the number of anionic groups contained in the hydrophobic-group-containing anionic polymer to the number of cationic groups contained in the hydrophobic-group-containing cationic polymer is 1.0 or more and 8 or less, and the aqueous pigment dispersion satisfies following Condition (i) or Condition (ii) below. The aqueous pigment dispersion according to the present invention may satisfy both Condition (i) Condition (ii).

Condition (i): The hydrophobic-group-containing anionic polymer has a molar ratio of the hydrophobic monomer structural units to the anionic monomer structural units being from 5/95 to 50/50;

Condition (ii): The aqueous pigment dispersion has a content of the pigment being 51 percent by weight or more based on the solids content thereof.

### <Definition of Monomer Structural Units>

As used herein, a “monomer structural unit” refers to a constitutional unit of a basic structure of a polymer. The “basic structure” of a polymer refers to a structure derived from a monomer molecule used in the production of the polymer through polymerization or copolymerization, or a modified structure thereof which is modified typically through denaturation. When the polymer is a naturally-occurring polymer, the “basic structure” refers to a repeating structure, or a modified structure thereof which is modified typically through denaturation.

### <Definitions of Number of Anionic Groups and Number of Cationic Groups>

As used herein, the “number of anionic groups contained in a hydrophobic-group-containing anionic polymer” refers to the total number of anionic groups in the entire hydrophobic-group-containing anionic polymer. The “number of cationic groups contained in a hydrophobic-group-containing cationic polymer” refers to the total number of cationic groups in the entire hydrophobic-group-containing cationic polymer.

### [Description of Hydrophobic-Group-Containing Cationic Polymer]

The hydrophobic-group-containing cationic polymer is not especially limited, as long as containing structural units of a cationic monomer and structural units of a hydrophobic monomer. The hydrophobic-group-containing cationic polymer contains cationic groups as a result of containing the cationic monomer structural units and it contains hydrophobic groups as a result of containing the hydrophobic monomer structural units.

The hydrophobic-group-containing cationic polymer is not limited in its primary structure, and specific examples thereof include, but are not limited to, linear, star, comb, branched, and block polymers. This polymer may be, for example, a synthetic polymer or naturally-occurring polymer, or a derivative or modified product of them.

The hydrophobic-group-containing cationic polymer is preferably a polymer that is soluble or dispersible in water.

### <Cationic Groups>

The cationic groups contained in the hydrophobic-group-containing cationic polymer are those capable of having a cationic charge in an aqueous medium, and examples thereof include groups derived from aliphatic amines, aromatic amines, and cyclic amines. These may have any structures of primary amines, secondary amines, tertiary amines, and quaternary ammonium salts. The structures further include structures of quaternized products of them, which are quaternized with a known quaternizing agent such as an alkyl halide, a benzyl halide, an alkyl- or aryl-sulfonic acid, or a dialkyl sulfate. Among them, a structure of a quaternary ammonium salt is more preferred for the following reasons.

Specifically, upon dispersing of a pigment, charge repulsion is an important factor to ensure the dispersion stability of the pigment. Of the above-listed cationic groups, a quaternary ammonium salt is most likely to be in a dissociation state in an aqueous solution. In addition, the quaternary ammonium salt can keep its dissociation state even at a pH in an alkaline range, and thereby, even when the pH is changed to an alkaline range upon addition of a hydrophobic-group-containing anionic polymer (in the subsequent step), the hydrophobic-group-containing anionic polymer can be adsorbed without suffering from destruction of the dispersion due to pH change. It is therefore more preferred to select such a quaternary ammonium salt.

### <Hydrophobic Groups>

Exemplary hydrophobic groups to be contained in the hydrophobic-group-containing cationic polymer include groups derived from aliphatic hydrocarbons each having one or more carbon atoms; and groups derived from aromatic hydrocarbons.

The aliphatic hydrocarbons herein may be saturated or unsaturated and can have any of linear, branched, and cyclic structures. These aliphatic hydrocarbons and aromatic hydrocarbons may each have one or more hydrogen atoms being substituted with a halogen atom such as fluorine, bromine, iodine, or chlorine. The aromatic hydrocarbons may each have one or more hydrogen atoms being substituted with an aliphatic hydrocarbon group (having one or more carbon atoms).

Among them, more preferred as hydrophobic groups to be contained in the hydrophobic-group-containing cationic polymer are groups derived from aliphatic hydrocarbons (of which aliphatic hydrocarbons having 4 or more and 18 or less carbon atoms are furthermore preferred); groups derived from alicyclic hydrocarbons (of which alicyclic hydrocarbons having 4 or more and 10 or less carbon atoms are furthermore preferred); and groups derived from aromatic hydrocarbons.

### <Introduction of Cationic Monomer Structural Units and Hydrophobic Monomer Structural Units>

Exemplary processes for introducing cationic monomer structural units and hydrophobic monomer structural units into the structure of a polymer to constitute a hydrophobic-group-containing cationic polymer include a process of polymerizing polymerizable monomers including at least one type of cationic monomer and at least one type of hydrophobic monomer to give a polymer; and a process of polymerizing polymerizable monomers not containing cationic groups and/or hydrophobic groups to give a polymer, and introducing cationic groups and/or hydrophobic groups into the polymer structure through a denaturation or modification reaction.

### Cationic Monomer Structural Units

The cationic monomer structural units are structural units of a monomer that contains a cationic group. Exemplary cationic monomer structural units include structures of monomers listed below, but are not limited thereto, and any known structures of cationic monomers will do.

Exemplary structural units of acrylate and methacrylate monomers include amino-(methyl, ethyl, propyl, or butyl) acrylate or methacrylate, methylamino-(methyl, ethyl, propyl, or butyl) acrylate or methacrylate, ethylamino-(methyl, ethyl, propyl, or butyl) acrylate or methacrylate, n-propylamino-(methyl, ethyl, propyl, or butyl) acrylate or methacrylate, butylamino-(methyl, ethyl, propyl, or butyl) acrylate or methacrylate, dimethylamino-(methyl, ethyl, propyl, or butyl) acrylate or methacrylate, diethylamino-(methyl, ethyl, propyl, or butyl) acrylate or methacrylate, di-n-propylamino-(methyl, ethyl, propyl, or butyl) acrylate or methacrylate, diisopropylamino-(methyl, ethyl, propyl, or butyl) acrylate or methacrylate, di-n-butylamino-(methyl, ethyl, propyl, or butyl) acrylate or methacrylate, di-sec-butylamino-(methyl, ethyl, propyl, or butyl) acrylate or methacrylate, and diisobutylamino-(methyl, ethyl, propyl, or butyl) acrylate or methacrylate; or neutralized salts of them typically with a hydrohalic acid, sulfuric acid, nitric acid, or an organic acid; and quaternized products of them typically with an alkyl halide, a benzyl halide, dimethyl sulfate, or diethyl sulfate.

Exemplary structural units of vinylpyridine monomers include vinylpyridine, 2-methyl-5-vinylpyridine, 2-ethyl-5-vinylpyridine; or neutralized salts of them typically with a hydrohalic acid, sulfuric acid, nitric acid, or an organic acid; and quaternized products of them typically with an alkyl halide, a benzyl halide, dimethyl sulfate, or diethyl sulfate.

Exemplary structural units of aminostyrenic monomers include N,N-dimethylaminostyrene, N,N-dimethylaminomethylstyrene; or neutralized salts of them typically with a hydrohalic acid, sulfuric acid, nitric acid, or an organic acid; and quaternized products of them typically with an alkyl halide, a benzyl halide, dimethyl sulfate, or diethyl sulfate.

It is enough for the hydrophobic-group-containing cationic polymer to contain one or more types of these cationic monomer structural units, and the polymer may contain two or more types of them.

Among them, preferred are cationic monomer structural units having a structure derived from a quaternary ammonium salt or a tertiary amine being quaternized typically with an alkyl halide, a benzyl halide, dimethyl sulfate, or diethyl sulfate; of which monomer structural units of salts of (meth)acryloyloxyethyltrimethylammonium (hereinafter “(meth)acryloyl” means “methacryloyl or acryloyl”) and benzyl chloride salt of (meth)acryloyloxyethyldimethyl are more preferred.

### Hydrophobic Monomer Structural Units

The hydrophobic monomer structural units are structural units of a monomer that contains neither anionic group nor cationic group but contains a hydrophobic group. It may contain a nonionic hydrophilic group or not. When it contains a nonionic hydrophilic group, the content of a hydrophobic group is preferably more than 2.5 times by weight the content of the nonionic hydrophilic group.

As used herein the term “nonionic hydrophilic group” refers to a hydrophobic chemical bond or functional group, such as an amide bond, a polyalkyl ether bond (with a repetition number of 2 or more) whose alkyl moiety has 2 to 5 carbon atoms, a hydroxyl group, a thiol group, an amido group, or a sulfonamido group.

Exemplary hydrophobic monomer structural units include structures of monomers listed below, but are not limited thereto, and any known hydrophobic monomer structures will do.

Exemplary structural units of acrylate monomers include methyl acrylate, ethyl acrylate, n-propyl acrylate, n-butyl acrylate, pentyl acrylate, hexyl acrylate, heptyl acrylate, octyl acrylate, dodecyl acrylate, octadecyl acrylate, chloromethyl acrylate, dichloromethyl acrylate, trichloromethyl acrylate, trifluoromethyl acrylate, bromoethyl acrylate, vinyl acrylate, allyl acrylate, propargyl acrylate, i-propyl acrylate, i-butyl acrylate, sec-butyl acrylate, t-butyl acrylate, isodecyl acrylate, 2-ethylhexyl acrylate, isopentyl acrylate, isopropenyl acrylate, 3-butenyl acrylate, cyclohexyl acrylate, cyclopentyl acrylate, isobornyl acrylate, dicyclopentenyl acrylate, phenyl acrylate, naphthyl acrylate, anthracenyl acrylate, diphenylethyl acrylate, benzyl acrylate, phenethyl acrylate, phenylbutyl acrylate, diphenylethyl acrylate, diphenylmethyl acrylate, triphenylmethyl acrylate, naphthylmethyl acrylate, and naphthylethyl acrylate.

Exemplary structural units of methacrylate monomers include methyl methacrylate, ethyl methacrylate, n-propyl methacrylate, n-butyl methacrylate, pentyl methacrylate, hexyl methacrylate, heptyl methacrylate, octyl methacrylate, dodecyl methacrylate, octadecyl methacrylate, chloromethyl methacrylate, dichloromethyl methacrylate, trichloromethyl methacrylate, trifluoromethyl methacrylate, bromoethyl methacrylate, vinyl methacrylate, allyl methacrylate, propargyl methacrylate, i-propyl methacrylate, i-butyl methacrylate, sec-butyl methacrylate, t-butyl methacrylate, isodecyl methacrylate, 2-ethylhexyl methacrylate, isopentyl methacrylate, isopropenyl methacrylate, 3-butenyl methacrylate, cyclohexyl methacrylate, cyclopentyl methacrylate, isobornyl methacrylate, dicyclopentenyl methacrylate, phenyl methacrylate, naphthyl methacrylate, anthracenyl methacrylate, diphenylethyl methacrylate, benzyl methacrylate, phenethyl methacrylate, phenylbutyl methacrylate, diphenylethyl methacrylate, diphenylmethyl methacrylate, triphenylmethyl methacrylate, naphthylmethyl methacrylate, and naphthylethyl methacrylate.

Exemplary structural units of styrenic monomers include styrene, o-methoxystyrene, m-methoxystyrene, p-methoxystyrene, o-t-butoxystyrene, m-t-butoxystyrene, p-t-butoxystyrene, o-chloromethylstyrene, m-chloromethylstyrene, p-chloromethylstyrene, p-hydroxymethylstyrene, p-(2-hydroxyethyl)styrene, and p-(2-hydroxyethyloxycarbonyl)styrene.

Exemplary structural units of (meth)acrylamide monomers include N-alkyl(meth)acrylamides whose alkyl moiety has 5 or more carbon atoms; and N,N-dialkyl(meth)acrylamides whose alkyl moiety has 3 or more carbon atoms.

Exemplary structural units of vinyl ether monomers include methyl vinyl ether, ethyl vinyl ether, n-propyl vinyl ether, i-propyl vinyl ether, i-butyl vinyl ether, t-butyl vinyl ether, benzyl vinyl ether, dodecyl vinyl ether, and stearyl vinyl ether.

Exemplary structural units of acrylonitrile monomers include acrylonitrile and methacrylonitrile. Exemplary structural units of allyl ester monomers include allyl acetate.

It is enough for the hydrophobic-group-containing cationic polymer to contain one or more types of these hydrophobic monomer structural units, but the polymer may contain two or more types of them.

Among them, more preferred are styrenes and (meth)acrylates (hereinafter “(meth)acrylate” means “methacrylate or acrylate”) whose hydrophobic group is a group derived from an aliphatic hydrocarbon having 4 or more and 12 or less carbon atoms or from an aromatic compound. Particularly preferred as monomer structural units to be contained are styrene, n-butyl(meth)acrylate, t-butyl (meth)acrylate, 2-ethylhexyl(meth)acrylate, dodecyl (meth)acrylate, and benzyl(meth)acrylate.

### <Process for Synthesizing Hydrophobic-Group-Containing Cationic Polymer>

A process to synthesize such a hydrophobic-group-containing cationic polymer containing cationic monomer structural units and hydrophobic monomer structural units as mentioned above can be selected from among known processes. Typically, a known polymerization process such as radical polymerization, ionic polymerization, polyaddition, or polycondensation can be selected. The hydrophobic-group-containing cationic polymer may be also a derivative or modified product of a polymer synthesized through such a known polymerization process. Among such polymers, a polymer synthesized through radical polymerization is more preferred, because the synthesis can be carried out according to an easy and convenient procedure.

### Monomers for Use in Radical Polymerization

For synthesizing the hydrophobic-group-containing cationic polymer through radical polymerization, it is enough to use at least one type of radically polymerizable cationic monomer and at least one type of radically polymerizable hydrophobic monomer, but any other polymerizable monomers may be used in addition.

Radically polymerizable cationic monomers to be used herein can be the cationic monomers listed as monomer structures constituting the hydrophobic-group-containing cationic polymer, but are not limited thereto, and any known ones will do.

It is enough to use at least one type of radically polymerizable cationic monomer, but two or more types of them may be used.

As radically polymerizable cationic monomers, in particular, preferred are those having structures derived from a quaternary ammonium salt or a tertiary amine being quaternized typically with an alkyl halide, a benzyl halide, dimethyl sulfate, or diethyl sulfate, of which monomers of salts of (meth)acryloyloxyethyltrimethylammonium and benzyl chloride salt of (meth)acryloyloxyethyldimethyl are more preferred.

Radically polymerizable hydrophobic monomers for use herein can be the hydrophobic monomers listed as monomer structures constituting the hydrophobic-group-containing cationic polymer, but are not limited thereto, and any known ones will do.

It is enough to use at least one type of radically polymerizable hydrophobic monomer, but two or more types of them may be used.

Among them, preferred as radically polymerizable hydrophobic monomers are styrenes and (meth)acrylates whose hydrophobic group is a group derived from an aliphatic hydrocarbon having 4 or more and 12 or less carbon atoms or from an aromatic compound, of which styrene, n-butyl (meth)acrylate, t-butyl(meth)acrylate, 2-ethylhexyl (meth)acrylate, dodecyl(meth)acrylate, and benzyl (meth)acrylate are more preferred.

### Proportion of Respective Monomer Structural Units in Hydrophobic-Group-Containing Cationic Polymer

The molar ratio of the hydrophobic monomer structural units to the cationic monomer structural units in the hydrophobic-group-containing cationic polymer for use herein is preferably 40/60 to 90/10, and more preferably 60/40 to 80/20.

A hydrophobic-group-containing cationic polymer, if containing hydrophobic monomer structural units more than this range and cationic monomer structural units less than this range, may have markedly decreased water solubility and be difficult to help the pigment to disperse easily. In contrast, a hydrophobic-group-containing cationic polymer, if containing hydrophobic monomer structural units less than this range and cationic monomer structural units more than this range, may be less adsorbed on the pigment, be likely to be desorbed from the pigment, to thereby often impair the dispersion stability.

### Polymerization Reaction Solvents

A radical polymerization reaction in the synthesis of the hydrophobic-group-containing cationic polymer may be carried out in the absence of, or in the presence of a solvent.

Exemplary polymerization reaction solvents include ethers such as diethyl ether, tetrahydrofuran, diphenyl ether, anisole, and dimethoxybenzene; amides such as N,N-dimethylformamide and N,N-dimethylacetamide; nitrites such as acetonitrile, propionitrile, and benzonitrile; carbonyl compounds such as acetone, methyl ethyl ketone, methyl isobutyl ketone, ethyl acetate, butyl acetate, ethylene carbonate, and propylene carbonate; alcohols such as methanol, ethanol, propanol, isopropanol, n-butyl alcohol, t-butyl alcohol, and isoamyl alcohol; aromatic hydrocarbons such as benzene, toluene, and xylenes; and halogenated hydrocarbons such as chlorobenzene, methylene chloride, chloroform, chlorobenzene, and carbon tetrachloride.

Among them, aqueous solvents are preferred as polymerization reaction solvents.

As used herein an “aqueous solvent” refers to a solvent of water alone (100% water), or a solvent as a mixture of water and a polar organic solvent in an arbitrary ratio. The polar organic solvent has only to be mixable with water in an arbitrary ratio. Exemplary polar organic solvents include protic solvents such as methanol, ethanol, and isopropanol; and aprotic solvents such as acetonitrile, acetone, dimethylformamide, dimethylsulfoxide, and tetrahydrofuran. Among them, methyl alcohol, ethyl alcohol, isopropyl alcohol, tetrahydrofuran, and water are especially preferred.

Such solvents may be used as a single solvent composed of one type of solvent or used as a solvent mixture composed of two or more types of them.

### Polymerization Initiators

Any known radical-polymerization initiators can be used in the radical polymerization reaction for the synthesis of the hydrophobic-group-containing cationic polymer. Any of water-soluble polymerization initiators and oil-soluble polymerization initiators can be used as the polymerization initiators.

### <Water-Soluble Polymerization Initiator>

Exemplary water-soluble polymerization initiators include azo compound initiators such as 2,2′-azobis(2-amidinopropane) dihydrochloride, 4,4′-azobis(4-cyanovaleric acid), 2,2′-azobis[2-(2-imidazolin-2-yl)propane]dihydrochloride, 2,2′-azobis[2-(2-imidazolin-2-yl)propane]disulfate dihydrate, 2,2′-azobis[N-(2-carboxyethyl)-2-methylpropionamide], 2,2′-azobis{2-[1-(2-hydroxyethyl)-2-imidazolin-2-yl)propane}dihydrochloride, 2,2′-azobis(1-imino-1-pyrrolidino-2-methylpropane) dihydrochloride, 2,2′-azobis{2-methyl-N-[2-(1-hydroxybutyl)]propionamide}, 2,2′-azobis[2-(5-methyl-imidazolin-2-yl)propane]dihydrochloride, and 2,2′-azobis[2-(3,4,5,6-tetrahydropyrimidin-2-yl)propane]dihydrochloride; initiators using an oxidizing agent alone, such as potassium persulfate, sodium persulfate, ammonium persulfate, and hydrogen peroxide; and redox initiators composed of such an oxidizing agent with a water-soluble reducing agent such as sodium sulfite, sodium hyposulfite, ferrous sulfate, ferrous nitrate, sodium formaldehyde sulfoxylate, or thiourea.

Each of these may be used alone or two or more of them may be used in combination.

### <Oil-Soluble Polymerization Initiators>

Exemplary oil-soluble polymerization initiator include azo compound initiators such as 2,2′-azobisisobutyronitrile, 2,2′-azobis(2-methylbutyronitrile), 1,1′-azobiscyclohexane-1-carbonitrile, 2,2′-azobis-4-methoxy-2,4-dimethylvaleronitrile, 2,2′-azobis-2,4-dimethylvaleronitrile, dimethyl-2,2′-azobis(2-methyl propionate), 1,1′-azobis(1-acetoxy-1-phenylethane), and 2,2′-azobis(4-methoxy-2,4-dimethylvaleronitrile); peroxide polymerization initiators such as acetylcyclohexylsulfonyl peroxide, isobutyryl peroxide, diisopropyl peroxydicarbonate, di-(2-ethylhexyl) peroxydicarbonate, 2,4-dichlorobenzoyl peroxide, t-butyl peroxypivalate, 3,5,5-trimethylhexanonyl peroxide, octanoyl peroxide, decanoyl peroxide, lauroyl peroxide, stearoyl peroxide, propionitrile peroxide, succinoyl peroxide, acetyl peroxide, t-butyl peroxy-2-ethylhexanoate, benzoyl peroxide, p-chlorobenzoyl peroxide, t-butyl peroxyisobutylate, t-butyl peroxymaleate, t-butyl peroxylaurate, cyclohexanone peroxide, t-butyl peroxyisopropyl carbonate, 2,5-dimethyl-2,5-dibenzoyl peroxyhexane, t-butyl peroxyacetate, t-butyl peroxybenzoate, diisobutyl diperoxyphthalate, methyl ethyl ketone peroxide, dicumyl peroxide, 2,5-dimethyl-2,5-di-t-butyl peroxyhexane, t-butylcumyl peroxide, t-butyl hydroperoxide, di-t-butyl peroxide, diisopropylbenzene hydroperoxide, p-menthane hydroperoxide, pinane hydroperoxide, 2,5-dimethylhexane-2,5-dihydroperoxide, and cumene peroxide; as well as oil-soluble redox polymerization initiators using an oil-soluble peroxide in combination with an oil-soluble reducing agent. Exemplary oil-soluble peroxides herein include hydroperoxides such as t-butyl hydroxyperoxide and cumene hydroxyperoxide; dialkyl peroxides such as lauroyl peroxide; and diacyl peroxides such as benzoyl peroxide. Exemplary oil-soluble reducing agents include tertiary amines such as triethylamine and tributylamine; salts of naphthenic acid; mercaptans such as mercaptoethanol and lauryl mercaptan; organometallic compounds such as triethylaluminum, triethylboron, and diethylzinc.

Each of these may be used alone or two or more of them may be used in combination.

### Chain-Transfer Agents

The polymerization reaction may be carried out in the presence of a chain-transfer agent.

The chain-transfer agent is not especially limited, and examples thereof include thiol-type chain-transfer agents such as methyl mercaptan, ethyl mercaptan, isopropyl mercaptan, n-butyl mercaptan, t-butyl mercaptan, n-hexyl mercaptan, n-octyl mercaptan, n-dodecyl mercaptan, ethyl thioglycolate, mercaptoethanol, thio-p-naphthol, and thiophenol.

Each of these may be used alone or two or more of them may be used in combination.

### Polymerization Conditions

When a polymerization reaction is carried out, procedures such as the order of adding components such as a radically polymerizable monomer, a polymerization reaction solvent, a radical-polymerization initiator, and a chain-transfer agent are arbitrarily selected. An exemplary process is a process of placing all the materials including the radically polymerizable monomer, chain-transfer agent, polymerization reaction solvent, and radical-polymerization initiator in a reactor; raising the temperature; and carrying out a polymerization reaction. Another exemplary process is a process of placing the radically polymerizable monomer, chain-transfer agent, and polymerization reaction solvent in a reactor; raising the temperature; adding a monomer solution containing the radical-polymerization initiator, as well as the chain-transfer agent, the polymerization reaction solvent, or a mixture of them continuously or in plural installments; and carrying out a polymerization reaction. Among these processes, the process of placing all the materials in a reactor, then raising the temperature, and carrying out a polymerization reaction is preferred, for easiness and convenience of the procedures.

The amount of the polymerization reaction solvent is not especially limited, but is generally 1 part by weight or more and is generally 2000 parts by weight or less, and preferably 1000 parts by weight or less, per 100 parts by weight of monomers.

The polymerization temperature is not especially limited, but is generally 0° C. or higher, and preferably 20° C. or higher, and the upper limit thereof is generally 200° C. or lower, and preferably 150° C. or lower.

The amount of the chain-transfer agent is not especially limited, but is generally 0.01 part by weight or more, preferably 1 part by weight or more, and is generally 2000 parts by weight or less, and preferably 1000 parts by weight or less, per 100 parts by weight of monomers.

The amount of the radical-polymerization initiator is not especially limited, but is generally 0.001 to 10 parts by weight, preferably 0.01 to 5 parts by weight, and more preferably 0.01 to 1 part by weight, per 100 parts by weight of monomers.

### Purification

The hydrophobic-group-containing cationic polymer obtained as above may be used as intact without purification with no problem, but is preferably purified according to a common procedure and then subjected to the subsequent pigment dispersing step. Exemplary purification processes include purification through reprecipitation where a polymer solution is added dropwise to a solvent, in which the polymer is insoluble but the monomers and the catalyst are soluble, to thereby precipitate the polymer, the precipitated polymer is separated by filtration, and the procedures of precipitation and separation by filtration of the polymer are repeated; purification through fractionation and precipitation, where a solvent, in which the polymer is insoluble but the monomers and the catalyst are soluble, is added dropwise to a polymer solution to precipitate the polymer, the precipitated polymer is separated by filtration, and the procedure of precipitation and separation by filtration of the polymer are repeated; a process where unreacted monomers and the reaction solvent are removed typically by distillation with heating or distillation under reduced pressure, and the solvent is then replaced by water and/or an aqueous solvent; and a process where low-molecular impurities and low-molecular-weight oligomer components are further removed typically using an ultrafilter membrane or dialysis membrane.

### <Molecular Weight>

The number-average molecular weight of the hydrophobic-group-containing cationic polymer for use in the present invention is preferably 50000 or less, more preferably 45000 or less, and is preferably 500 or more, and more preferably 1000 or more. If the molecular weight is larger than this range, the resulting aqueous pigment dispersion may have an increased viscosity. If it is smaller than this range, the dispersing agent may be likely to be detached from the surface of the pigment, and this may cause unstable dispersing.

### [Description of Hydrophobic-Group-Containing Anionic Polymer]

The hydrophobic-group-containing anionic polymer for use in the present invention is not especially limited, as long as containing structural units of an anionic monomer and structural units of a hydrophobic monomer. The hydrophobic-group-containing anionic polymer contains anionic group as a result of containing anionic monomer structural units and it contains hydrophobic groups as a result of containing hydrophobic monomer structural units.

The hydrophobic-group-containing anionic polymer is not limited in its primary structure, and specific examples thereof include, but are not limited to, linear, star, comb, branched, and block polymers. This polymer may be, for example, a synthetic polymer or a naturally-occurring polymer, or a derivative or modified product of them.

The hydrophobic-group-containing anionic polymer is preferably a polymer that is soluble or dispersible in water.

### <Anionic Groups>

The anionic groups contained in the hydrophobic-group-containing anionic polymer are functional groups which are capable of having an anionic charge in an aqueous medium and have a pKa of 8 or less. Examples of such anionic groups include structures of acidic groups derived from acids such as carboxylic acids, sulfonic acid, and phosphoric acid; and alkali metal salts or alkaline earth metal salts of them. Among these, more preferred are structures of carboxylic acids, alkali metal salts of carboxylic acids, and alkaline earth metal salts of carboxylic acids (hereinafter an “alkali metal salt and/or alkaline earth metal salt” is also referred to as an “alkaline (earth) metal salt”) for the following reasons.

Specifically, a carboxylic acid and/or an alkaline (earth) metal salt of a carboxylic acid easily aggregates on a paper due to pH change, is thereby expected to work to improve the optical density (print density), and is more preferred.

### <Hydrophobic Groups>

Exemplary hydrophobic groups to be contained in the hydrophobic-group-containing anionic polymer include groups derived from aliphatic hydrocarbons each having one or more carbon atoms; and groups derived from aromatic hydrocarbons.

The aliphatic hydrocarbons may be saturated or unsaturated and can have any of linear, branched, and cyclic structures. These aliphatic hydrocarbons and aromatic hydrocarbons may each have one or more hydrogen atoms being substituted with a halogen atom such as fluorine, bromine, iodine, or chlorine. The aromatic hydrocarbons may each have one or more hydrogen atoms being substituted with an aliphatic hydrocarbon group (having one or more carbon atoms).

Among them, more preferred as hydrophobic groups to be contained in the hydrophobic-group-containing anionic polymer are groups derived from aliphatic hydrocarbons (of which aliphatic hydrocarbons having 4 or more and 18 or less carbon atoms are furthermore preferred); groups derived from alicyclic hydrocarbons (of which alicyclic hydrocarbons having 4 or more and 10 or less carbon atoms are furthermore preferred); and groups derived from aromatic hydrocarbons.

### <Introduction of Anionic Monomer Structural Units and Hydrophobic Monomer Structural Units>

Exemplary processes for introducing anionic monomer structural units and hydrophobic monomer structural units into the structure of a polymer to constitute a hydrophobic-group-containing anionic polymer include a process of polymerizing polymerizable monomers including at least one type of anionic monomer and at least one type of hydrophobic monomer to give a polymer; and a process of polymerizing polymerizable monomers not containing anionic groups and/or hydrophobic groups to give a polymer, and introducing anionic groups and/or hydrophobic groups into the polymer through a denaturation or modification reaction.

### Anionic Monomer Structural Units

The anionic monomer structural units are structural units of a monomer that contains an anionic group. Exemplary anionic monomer structural units include structures of monomers listed below, but are not limited thereto, and any known anionic monomer structures will do.

Exemplary anionic monomer structural units include structures of carboxylic acid monomers such as acrylic acid, methacrylic acid, itaconic acid, maleic acid, and fumaric acid; structures of sulfonic acid monomers such as vinylsulfonic acid, allylsulfonic acid, methacrylsulfonic acid, styrenesulfonic acid, 2-acrylamidoethanesulfonic acid, 2-acrylamido-2-methylpropanesulfonic acid, 2-methacrylamidoethanesulfonic acid, 2-methacrylamido-2-methylpropanesulfonic acid, 2-acryloyloxyethanesulfonic acid, 3-acryloyloxypropanesulfonic acid, 4-acryloyloxybutanesulfonic acid, 2-methacryloyloxyethanesulfonic acid, 3-methacryloyloxypropanesulfonic acid, and 4-methacryloyloxybutanesulfonic acid; structures of phosphoric acid monomers such as vinylphosphonic acid, methacryloxyethyl phosphate, diphenyl-2-acryloyloxyethyl phosphate, diphenyl-2-methacryloyloxyethyl phosphate, dibutyl-2-acryloyloxyethyl phosphate, dibutyl-2-methacryloyloxyethyl phosphate, and dioctyl-2-(meth)acryloyloxyethyl phosphate; and structures of metal salts (e.g., alkali metal salts and alkaline earth metal salts) or ammonium salts of them.

It is enough for the hydrophobic-group-containing anionic polymer to contain one or more types of these anionic monomer structural units, but the polymer may contain two or more types of them.

Among them, preferred are anionic monomer structural units having structures of an anionic monomer having a structure of a carboxylic acid, of which more preferred are structural units of a monomer derived from acrylic acid, methacrylic acid, itaconic acid, maleic acid, or fumaric acid and/or an alkaline (earth) metal salt of them.

### Hydrophobic Monomer Structural Units

Exemplary hydrophobic monomer structural units include the hydrophobic monomer structural units listed above in the description of the hydrophobic-group-containing anionic polymer, but are not limited thereto, and any known hydrophobic monomer structural units will do.

It is enough for the hydrophobic-group-containing anionic polymer to contain one or more types of these hydrophobic monomer structural units, but the polymer may contain two or more types of them.

Among them, typically preferred are monomer structures derived from styrenes and (meth)acrylic acid monomers whose hydrophobic group is derived from an aromatic hydrocarbon or an alicyclic hydrocarbon. More preferred as monomer structural units to be contained are styrene, benzyl (meth)acrylate, cyclohexyl(meth)acrylate, and isobornyl (meth)acrylate.

### Nonionic Hydrophilic Monomer Structural Units

The hydrophobic-group-containing anionic polymer for use in the present invention may further contain structural units of a monomer having a nonionic hydrophilic group (nonionic hydrophilic monomer structural units) as monomer structural units in addition to the anionic monomer structural units and hydrophobic monomer structural units.

The nonionic hydrophilic monomer structural units are structural units of a monomer containing neither anionic group nor cationic group but containing a nonionic hydrophilic group. It may contain a hydrophobic group or not. When it contains a hydrophobic group, the content of the hydrophobic group is preferably 2.5 times by weight or less the content of the nonionic hydrophilic group.

As used herein the term “nonionic hydrophilic group” refers to a hydrophobic chemical bond or functional group, such as an amide bond, a polyalkyl ether bond (with a repetition number of 2 or more) whose alkyl moiety has 2 to 5 carbon atoms, a hydroxyl group, a thiol group, an amido group, or a sulfonamido group.

Exemplary nonionic hydrophilic monomer structural units include structures of monomers listed below, but are not limited thereto, and any known nonionic hydrophilic monomer structures will do.

Specifically, exemplary nonionic hydrophilic monomer structural units include N-vinyl-2-pyrrolidone, N-vinyloxazolidone, N-vinyl-5-methyloxazolidone, 2-hydroxyethyl(meth)acrylate, 2,3-dihydroxypropyl (meth)acrylate, 2-(N-pyrrolidone)ethyl(meth)acrylate, N-acryloylpiperidine, N-(meth)acryloylpyrrolidine, N-vinyllactams having 4 or 5 carbon atoms, vinyl alcohol, hydroxyethyl(meth)acrylate, hydroxypropyl(meth)acrylate, allyl alcohol, methallyl alcohol, glycerol monoallyl ether, (meth)acrylamide, N-alkyl(meth)acrylamides whose alkyl moiety having 1 to 4 carbon atoms, N,N-dialkyl(meth)acrylamides whose alkyl moiety having 1 or 2 carbon atoms, diacetone(meth)acrylamide, N-methylol(meth)acrylamide, N-(2-hydroxyethyl)acrylamide, N,N-diethanolacrylamide, N-vinylacetamide, N-methyl-N-vinylacetamide, N-vinylformamide, N-methyl-N-vinylformamide, N-(2-(poly(ethylene glycol))ethyl)(meth)acrylamides, N,N-(2,2′-(poly(ethylene glycol))diethyl)(meth)acrylamides, poly(ethylene glycol) (meth)acrylates, methoxy-poly(ethylene glycol) (meth)acrylates, ethoxy-poly(ethylene glycol) (meth)acrylates, lauryloxy-poly(ethylene glycol) (meth)acrylates each having 3 or more ethylene glycol repeating units, stearyloxy-poly(ethylene glycol) (meth)acrylates each having 4 or more ethylene glycol repeating units, phenoxy-poly(ethylene glycol) (meth)acrylates, poly(propylene glycol) (meth)acrylates, poly(ethylene glycol-propylene glycol) (meth)acrylates, poly(ethylene glycol)-poly(propylene glycol) (meth)acrylates, poly(ethylene glycol-tetramethylene glycol) (meth)acrylates, poly(propylene glycol-tetramethylene glycol) (meth)acrylates, propylene glycol poly(butylene glycol) (meth)acrylate, octyloxy-poly(ethylene glycol) poly(propylene glycol) (meth)acrylates, allyloxy-poly(ethylene glycol)-poly(propylene glycol) (meth)acrylates, and other (meth)acrylates each containing a ring-opened structure of an alkylene oxide having 2 to 5 carbon atoms, which are classified into nonionic hydrophilic groups.

Among them, preferred as nonionic hydrophilic monomer structural units are poly(ethylene glycol) (meth)acrylates, methoxy-poly(ethylene glycol) (meth)acrylates, and N-vinylpyrrolidone.

The hydrophobic-group-containing anionic polymer may contain one type of these nonionic hydrophilic monomer structural units or may contain two or more types of them.

### <Process for Synthesizing Hydrophobic-Group-Containing Anionic Polymer>

A process to synthesize such a hydrophobic-group-containing anionic polymer containing anionic monomer structural units and hydrophobic monomer structural units and optionally further containing nonionic hydrophilic monomer structural units can be selected from among known processes. Typically, a known polymerization process such as radical polymerization, ionic polymerization, polyaddition, or polycondensation can be selected. The hydrophobic-group-containing anionic polymer may also be a derivative or modified product of a polymer synthesized through such a known polymerization process. Among these polymers, a polymer synthesized through radical polymerization is more preferred, because the synthesis can be carried out according to an easy and convenient procedure.

### Monomers for Use in Radical Polymerization

For synthesizing the hydrophobic-group-containing anionic polymer through radical polymerization, it is enough to use at least one type of radically polymerizable anionic monomer and at least one type of radically polymerizable hydrophobic monomer. In addition, a radically polymerizable nonionic hydrophilic monomer may be used and/or any other radically polymerizable monomer may also be used.

Radically polymerizable anionic monomers to be used herein can be the anionic monomers listed as monomer structures constituting the hydrophobic-group-containing anionic polymer, but are not limited thereto, and any known ones will do.

Among them, preferred as radically polymerizable anionic monomers are those having structures of carboxylic acids, of which more preferred are monomers of acrylic acid, methacrylic acid, itaconic acid, maleic acid, or fumaric acid and/or alkaline (earth) metal salts of them.

It is enough to use at least one type of radically polymerizable anionic monomer as a polymerization monomer, but two or more types of them may be used.

Radically polymerizable hydrophobic monomers for use herein can be the hydrophobic monomers exemplified in the description of the hydrophobic-group-containing cationic polymer, but are not limited thereto, and any known ones will do.

Among them, preferred as radically polymerizable hydrophobic monomers are radically polymerizable hydrophobic monomers belonging to styrenes and (meth)acrylic acid monomers whose hydrophobic group is derived from an aromatic hydrocarbon or an alicyclic hydrocarbon, of which styrene, benzyl(meth)acrylate, cyclohexyl(meth)acrylate, and isobornyl(meth)acrylate are more preferred.

It is enough to use at least one type of radically polymerizable hydrophobic monomer as a polymerization monomer, but two or more types of them may be used.

The radically polymerizable nonionic hydrophilic monomers for use herein can be any of the nonionic hydrophilic monomers exemplified as nonionic hydrophilic monomer structures which may be contained in the hydrophobic-group-containing anionic polymer, but are not limited thereto, and any known ones will do.

It is enough to use at least one type of radically polymerizable nonionic hydrophilic monomer as a polymerization monomer, but two or more types of them may be used.

### Proportion of Respective Monomer Structural Units in Hydrophobic-Group-Containing Anionic Polymer

The molar ratio of the hydrophobic monomer structural units to the anionic monomer structural units in the hydrophobic-group-containing anionic polymer for use in the present invention is preferably from 5/95 to 50/50, and more preferably from 10/90 to 50/50.

A hydrophobic-group-containing anionic polymer, if containing hydrophobic monomer structural units less than this range and anionic monomer structural units more than this range, may be detached from the surface of the pigment to decrease the dispersion stability or to increase the viscosity. In contrast, a hydrophobic-group-containing anionic polymer, if containing hydrophobic monomer structural units more than this range and anionic monomer structural units less than this range, may cause an insufficient number of anionic groups dissociated on the surface of the pigment less than a desired proportion, whereby suffer from decreased dispersion stability, decreased discharge properties, and impaired gloss of a print.

The content of nonionic hydrophilic monomer structural units, if further contained in the hydrophobic-group-containing anionic polymer for use in the present invention, is 50 percent by mole or less, and more preferably 40 percent by mole or less. A hydrophobic-group-containing anionic polymer, if further containing nonionic hydrophilic monomer structural units, effectively helps to improve the discharge properties and gloss. However, if the polymer contains nonionic hydrophilic monomer structural units more than the above-specified upper limit, the contents of hydrophobic monomer structural units and of anionic monomer structural units become excessively small, and this may adversely affect the dispersion stability.

### Polymerization Reaction Solvents

A radical polymerization reaction in the synthesis of the hydrophobic-group-containing anionic polymer may be carried out in the absence of, or in the presence of a solvent.

Exemplary polymerization reaction solvents include ethers such as diethyl ether, tetrahydrofuran, diphenyl ether, anisole, and dimethoxybenzene; amides such as N,N-dimethylformamide and N,N-dimethylacetamide; nitrites such as acetonitrile, propionitrile, and benzonitrile; carbonyl compounds such as acetone, methyl ethyl ketone, methyl isobutyl ketone, ethyl acetate, butyl acetate, ethylene carbonate, and propylene carbonate; alcohols such as methanol, ethanol, propanol, isopropanol, n-butyl alcohol, t-butyl alcohol, and isoamyl alcohol; aromatic hydrocarbons such as benzene, toluene, and xylenes; and halogenated hydrocarbons such as chlorobenzene, methylene chloride, chloroform, chlorobenzene, and carbon tetrachloride.

Among them, aqueous solvents are preferred as polymerization reaction solvents.

As used herein an “aqueous solvent” refers to a solvent of water alone (100% water), or a solvent as a mixture of water and a polar organic solvent in an arbitrary ratio. The polar organic solvent has only to be mixable with water in an arbitrary ratio. Exemplary polar organic solvents include protic solvents such as methanol, ethanol, and isopropanol; and aprotic solvents such as acetonitrile, acetone, dimethylformamide, dityl sulfoxide, and tetrahydrofuran. Among them, methyl alcohol, ethyl alcohol, isopropyl alcohol, tetrahydrofuran, and water are especially preferred.

Such solvents may be used as a single solvent composed of one type of solvent or used as a solvent mixture composed of two or more types of them.

### Polymerization Initiators

Any known radical-polymerization initiators can be used in the radical polymerization reaction for the synthesis of the hydrophobic-group-containing anionic polymer. Any of water-soluble polymerization initiators and oil-soluble polymerization initiators can be used as the polymerization initiators.

### Water-Soluble Polymerization Initiators

Exemplary water-soluble polymerization initiators include azo compound initiators such as 2,2′-azobis(2-amidinopropane) dihydrochloride, 4,4′-azobis(4-cyanovaleric acid), 2,2′-azobis[2-(2-imidazolin-2-yl)propane]dihydrochloride, 2,2′-azobis[2-(2-imidazolin-2-yl)propane]disulfate dihydrate, 2,2′-azobis[N-(2-carboxyethyl)-2-methylpropionamide], 2,2′-azobis{2-[1-(2-hydroxyethyl)-2-imidazolin-2-yl)propane}dihydrochloride, 2,2′-azobis(1-imino-1-pyrrolidino-2-methylpropane) dihydrochloride, 2,2′-azobis{2-methyl-N-[2-(1-hydroxybutyl)]propionamide}, 2,2′-azobis[2-(5-methyl-imidazolin-2-yl)propane]dihydrochloride, and 2,2′-azobis[2-(3,4,5,6-tetrahydropyrimidin-2-yl)propane]dihydrochloride; initiators using an oxidizing agent alone, such as potassium persulfate, sodium persulfate, ammonium persulfate, or hydrogen peroxide; and redox initiators composed of such an oxidizing agent with a water-soluble reducing agent such as sodium sulfite, sodium hyposulfite, ferrous sulfate, ferrous nitrate, sodium formaldehyde sulfoxylate, or thiourea.

Each of these may be used alone or two or more of them may be used in combination.

### <Oil-Soluble Polymerization Initiators>

Exemplary oil-soluble polymerization initiators include azo compound initiators such as 2,2′-azobisisobutyronitrile, 2,2′-azobis(2-methylbutyronitrile), 1,1′-azobiscyclohexane-1-carbonitrile, 2,2′-azobis-4-methoxy-2,4-dimethylvaleronitrile, 2,2′-azobis-2,4-dimethylvaleronitrile, dimethyl-2,2′-azobis(2-methyl propionate), 1,1′-azobis(1-acetoxy-1-phenylethane), and 2,2′-azobis(4-methoxy-2,4-dimethylvaleronitrile); peroxide polymerization initiators such as acetylcyclohexylsulfonyl peroxide, isobutyryl peroxide, diisopropyl peroxydicarbonate, di-(2-ethylhexyl) peroxydicarbonate, 2,4-dichlorobenzoyl peroxide, t-butyl peroxypivalate, 3,5,5-trimethylhexanonyl peroxide, octanoyl peroxide, decanoyl peroxide, lauroyl peroxide, stearoyl peroxide, propionitrile peroxide, succinoyl peroxide, acetyl peroxide, t-butyl peroxy-2-ethylhexanoate, benzoyl peroxide, p-chlorobenzoyl peroxide, t-butyl peroxyisobutylate, t-butyl peroxymaleate, t-butyl peroxylaurate, cyclohexanone peroxide, t-butyl peroxyisopropyl carbonate, 2,5-dimethyl-2,5-dibenzoyl peroxyhexane, t-butyl peroxyacetate, t-butyl peroxybenzoate, diisobutyl diperoxyphthalate, methyl ethyl ketone peroxide, dicumyl peroxide, 2,5-dimethyl-2,5-di-t-butyl peroxyhexane, t-butylcumyl peroxide, t-butyl hydroperoxide, di-t-butyl peroxide, diisopropylbenzene hydroperoxide, p-menthane hydroperoxide, pinane hydroperoxide, 2,5-dimethylhexane-2,5-dihydroperoxide, and cumene peroxide; as well as oil-soluble redox polymerization initiators using an oil-soluble peroxide in combination with an oil-soluble reducing agent. Exemplary oil-soluble peroxides herein include hydroperoxides such as t-butyl hydroxyperoxide and cumene hydroxyperoxide; dialkyl peroxides such as lauroyl peroxide; and diacyl peroxides such as benzoyl peroxide. Exemplary oil-soluble reducing agents include tertiary amines such as triethylamine and tributylamine; salts of naphthenic acid; mercaptans such as mercaptoethanol and lauryl mercaptan; organometallic compounds such as triethylaluminum, triethylboron, and diethylzinc.

Each of these may be used alone or two or more of them may be used in combination.

### Chain-Transfer Agents

The polymerization reaction may be carried out in the presence of a chain-transfer agent.

The chain-transfer agent is not especially limited, and examples thereof include thiol-type chain-transfer agents such as methyl mercaptan, ethyl mercaptan, isopropyl mercaptan, n-butyl mercaptan, t-butyl mercaptan, n-hexyl mercaptan, n-octyl mercaptan, n-dodecyl mercaptan, ethyl thioglycolate, mercaptoethanol, thio-β-naphthol, and thiophenol.

Each of these may be used alone or two or more of them may be used in combination.

### Polymerization Conditions

When a polymerization reaction is carried out, procedures such as the order of adding components such as a radically polymerizable monomer, a polymerization reaction solvent, a radical-polymerization initiator, and a chain-transfer agent are arbitrarily selected. An exemplary process is a process of placing all the materials including the radically polymerizable monomer, chain-transfer agent, polymerization reaction solvent, and radical-polymerization initiator in a reactor; raising the temperature; and carrying out a polymerization reaction. Another exemplary process is a process of placing the radically polymerizable monomer, chain-transfer agent, and polymerization reaction solvent in a reactor; raising the temperature; adding a monomer solution containing the radical-polymerization initiator, as well as the chain-transfer agent, the polymerization reaction solvent, or a mixture of them continuously or in plural installments; and carrying out a polymerization reaction. Among these processes, the process of placing all the materials in a reactor, then raising the temperature, and carrying out a polymerization reaction is preferred, for easiness and convenience of the procedures.

The amount of the polymerization reaction solvent is not especially limited, but is generally 1 part by weight or more and is generally 2000 parts by weight or less, and preferably 1000 parts by weight or less, per 100 parts by weight of monomers.

The polymerization temperature is not especially limited, but is generally 0° C. or higher, and preferably 20° C. or higher, and the upper limit thereof is generally 200° C. or lower, and preferably 150° C. or lower.

The amount of the chain-transfer agent is not especially limited, but is generally 0.01 part by weight or more, preferably 1 part by weight or more, and is generally 2000 parts by weight or less, and preferably 1000 parts by weight or less, per 100 parts by weight of monomers.

The amount of the radical-polymerization initiator is not especially limited, but is generally 0.001 to 10 percent by weight, preferably 0.01 to 5 percent by weight, and more preferably 0.01 to 1 percent by weight, per 100 parts by weight of monomers.

### Purification

The hydrophobic-group-containing anionic polymer obtained as above may be used as intact without purification with no problem, but is preferably purified according to a common procedure and then subjected to the subsequent pigment dispersing step. Exemplary purification processes include purification through reprecipitation where a polymer solution is added dropwise to a solvent, in which the polymer is insoluble but the monomers and the catalyst are soluble, to thereby precipitate the polymer, the precipitated polymer is separated by filtration, and the procedures of precipitation and separation by filtration of the polymer are repeated; purification through fractionation and precipitation, where a solvent, in which the polymer is insoluble but the monomers and the catalyst are soluble, is added dropwise to a polymer solution to precipitate the polymer, the precipitated polymer is separated by filtration, and the procedure of precipitation and separation by filtration of the polymer are repeated; a process where unreacted monomers and the reaction solvent are removed typically by distillation with heating or distillation under reduced pressure, and the solvent is then replaced by water and/or an aqueous solvent; and a process where low-molecular impurities and low-molecular-weight oligomer components are further removed typically using an ultrafilter membrane or dialysis membrane.

### <Molecular Weight>

The number-average molecular weight of the hydrophobic-group-containing anionic polymer for use in the present invention is preferably 2000 or more, more preferably 3000 or more and is preferably 50000 or less, and more preferably 40000 or less. If the molecular weight is larger than this range, the resulting aqueous pigment dispersion may have an increased viscosity. If it is smaller than this range, the dispersing agent is likely to be detached from the surface of the pigment, and this may cause unstable dispersing.

### [Number of Cationic Groups and Number of Anionic Groups in Dispersion]

In the aqueous pigment dispersion according to the present invention, the ratio of the number of anionic groups in the hydrophobic-group-containing anionic polymer to the number of cationic groups in the hydrophobic-group-containing cationic polymer is preferably 1.0 or more and 8 or less. This ratio is more preferably 2 or more and 7 or less, and furthermore preferably 2.5 or more and 6 or less. If this ratio is less than 1, the amount of anionic groups in the dispersion which contribute to dispersing is insufficient to cause deterioration in storage stability and discharge stability, and further cause decrease in gloss. If this ratio is excessively high, the polymer adsorbed on the pigment in the dispersion may markedly spread, or the amount of polymer that is not adsorbed on the surface of the pigment may increase to thereby cause increase in viscosity or deterioration in storage stability.

Exemplary processes for analyzing the ratio between the number of anionic groups and the number of cationic groups in the dispersion include a process in which the dispersion is acidified to precipitate dispersoids, and the precipitated dispersoids are separated, polymers are extracted with a suitable organic solvent, NMR spectra of the extracted polymers are measured, from which the number of cationic groups and the number of anionic groups are estimated. When nitrogen atom is contained in the hydrophobic-group-containing cationic polymer but is not contained in the hydrophobic-group-containing anionic polymer, the ratio between the number of anionic groups and the number of cationic groups may also be determined in the following manner. Specifically, the weight ratio between the pigment and the polymers (total of the hydrophobic-group-containing cationic polymer and the hydrophobic-group-containing anionic polymer) is calculated from the nonvolatile components in the dispersion; the analytically measured value of nitrogen element in the pigment (starting material) is subtracted from the analytically measured value of nitrogen element in the dispersion to give a calculated value; and this value is compared with the analytically measured value of nitrogen element in the hydrophobic-group-containing cationic polymer (starting material) to thereby calculate the weight ratio between the hydrophobic-group-containing cationic polymer and the hydrophobic-group-containing anionic polymer; and further the ratio between the number of cationic groups and the number of anionic groups is calculated based on the compositional ratios of comonomers in the respective polymers.

[Pigments]

Pigments for use in the present invention may be selected from among those generally used in respective uses. Among them, pigments that, if existing alone, do not disperse in water are preferred, from the viewpoint of stably dispersing the pigments by the action of polymers. Additionally, more preferred pigments are those which are not chemically modified and which do not contain impurities other than pigments, such as crystallization inhibitors for reducing the particle diameter of pigments. This is because these pigments do not adversely affect the adsorption of the polymers on the pigments.

Though not limitative, representative pigments are as follows.

Inorganic pigments including:

extender pigments represented by calcium carbonate, kaolin clay, talc, bentonite, and mica;

metal oxide pigments represented by titanium oxide, zinc oxide, goethite, magnetite, and chromium oxide;

composite oxide pigments represented by Titan Yellow, Titan Buff, antimony yellow, vanadium-tin yellow, cobalt green, cobalt chromium green, manganese green, cobalt blue, cerulean blue, manganese blue, tungsten blue, Egyptian Blue, and cobalt black;

sulfide pigments represented by lithophone, cadmium red/yellow, and cadmium red;

phosphate pigments represented by mineral violet, cobalt violet, lithium cobalt phosphate, sodium cobalt phosphate, potassium cobalt phosphate, ammonium cobalt phosphate, nickel phosphate, and copper phosphate;

chromate pigments represented by chrome yellow and molybdate orange;

metal complex salt pigments represented by ultramarine blue and Persian Blue;

metal powder pigments represented by aluminum paste, bronze powder, zinc dust, stainless steel flake, and nickel flake; and

pearly luster pigments and pearly luster conductive pigments represented by carbon black, bismuth oxychloride, basic carbonate, titanium dioxide, coated mica, ITO (indium-tin oxide), and ATO (antimony-tin oxide); and

organic pigments such as quinacridone pigments, quinacridone quinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, metal complex pigments, azomethine pigments, and azo pigments.

Specific examples of the foregoing pigments include pigments having the pigment numbers as described below, and known carbon blacks which are generally used in the field of coloring materials. Incidentally, terms as listed below, such as “C.I. Pigment Red 2”, mean a color index (C.I.).

Red coloring materials: C.I. Pigment Red 1, 2, 3, 4, 5, 6, 7, 8, 9, 12, 14, 15, 16, 17, 21, 22, 23, 31, 32, 37, 38, 41, 47, 48, 48:1, 48:2, 48:3, 48:4, 49, 49:1, 49:2, 50:1, 52:1, 52:2, 53, 53:1, 53:2, 53:3, 54, 57, 57:1, 57:2, 58, 58:4, 60, 63, 63:1, 63:2, 64, 64:1, 68, 69, 81, 81:1, 81:2, 81:3, 81:4, 83, 88, 90:1, 101, 101:1, 104, 108, 108:1, 109, 112, 113, 114, 122, 123, 144, 146, 147, 149, 151, 166, 168, 169, 170, 172, 173, 174, 175, 176, 177, 178, 179, 181, 184, 185, 187, 188, 190, 193, 194, 200, 202, 206, 207, 208, 209, 210, 214, 216, 220, 221, 224, 230, 231, 232, 233, 235, 236, 237, 238, 239, 242, 243, 245, 247, 249, 250, 251, 253, 254, 255, 256, 257, 258, 259, 260, 262, 263, 264, 265, 266, 267, 268, 269, 270, 271, 272, 273, 274, 275, and 276;

Blue coloring materials: C.I. Pigment Blue 1, 1:2, 9, 14, 15, 15:1, 15:2, 15:3, 15:4, 15:6, 16, 17, 19, 25, 27, 28, 29, 33, 35, 36, 56, 56:1, 60, 61, 61:1, 62, 63, 66, 67, 68, 71, 72, 73, 74, 75, 76, 78, and 79;

Green coloring materials: C.I. Pigment Green 1, 2, 4, 7, 8, 10, 13, 14, 15, 17, 18, 19, 26, 36, 45, 48, 50, 51, 54, and 55;

Yellow coloring materials: C.I. Pigment Yellow 1, 1:1, 2, 3, 4, 5, 6, 9, 10, 12, 13, 14, 16, 17, 23, 24, 31, 32, 34, 35, 35:1, 36, 36:1, 37, 37:1, 40, 41, 42, 43, 48, 53, 55, 61, 62, 62:1, 63, 65, 73, 74, 75, 81, 83, 87, 93, 94, 95, 97, 100, 101, 104, 105, 108, 109, 110, 111, 116, 119, 120, 126, 127, 127:1, 128, 129, 133, 134, 136, 138, 139, 142, 147, 148, 150, 151, 153, 154, 155, 157, 158, 159, 160, 161, 162, 163, 164, 165, 166, 167, 168, 169, 170, 172, 173, 174, 175, 176, 180, 181, 182, 183, 184, 185, 188, 189, 190, 191, 191:1, 192, 193, 194, 195, 196, 197, 198, 199, 200, 202, 203, 204, 205, 206, 207, 208, and 215;

Orange coloring materials: C.I. Pigment Orange 1, 2, 5, 13, 16, 17, 19, 20, 21, 22, 23, 24, 34, 36, 38, 39, 43, 46, 48, 49, 61, 62, 64, 65, 67, 68, 69, 70, 71, 72, 73, 74, 75, 77, 78, and 79;

Violet coloring materials: C.I. Pigment Violet 1, 1:1, 2, 2:2, 3, 3:1, 3:3, 5, 5:1, 14, 15, 16, 19, 23, 25, 27, 29, 31, 32, 37, 39, 42, 44, 47, 49, and 50;

Brown coloring materials: C.I. Pigment Brown 1, 6, 11, 22, 23, 24, 25, 27, 29, 30, 31, 33, 34, 35, 37, 39, 40, 41, 42, 43, 44, and 45; and

Black coloring materials: C.I. Pigment Black 1, 31, and 32.

Among these pigments, preferred examples of red pigments include quinacridone pigments, xanthene pigments, perylene pigments, anthanthrone pigments, and monoazo pigments, and specific examples thereof include C.I. Pigment Red-5, -7, -12, -112, -81, -122, -123, 146, -147, -168, -173, -202, -206, -207, and -209, and C.I. Pigment Violet 19. Of these, more preferred are solid solutions composed of two or more types of quinacridone pigments and quinacridone pigments.

Among the above-mentioned pigments, monoazo pigments and disazo pigments are preferred as yellow pigments, because their color development as prints is good as compared with other pigments. Above all, C.I. Pigment Yellow-1, -3, -16, -17, -74, -95, -120, -128, -151, -155, -175, and -215 are especially preferable in view of hue thereof; and C.I. Pigment Yellow-74 and -155 are furthermore preferable typically because they are non-halogen compounds, scarcely affect the environment, and can be finely divided.

Among the above-mentioned pigments, copper phthalocyanine pigments are preferred as blue pigments, because their color development as prints is good as compared with other pigments. Above all, C.I. Pigment Blue-15:3 is preferable in view of hue thereof.

Further, a variety of carbon blacks such as acetylene black, channel black, and furnace black can be used in the present invention. Of these, channel black and furnace black are preferred, of which furnace black is especially preferred.

A dibutyl phthalate (DBP) oil absorption of the carbon black is preferably 40 ml/100 g or more, more preferably 50 ml/100 g or more, and especially preferably 60 ml/100 g or more from the viewpoint of optical density. The upper limit thereof is preferably 250 ml/100 g or less, and especially preferably 200 ml/100 g or less. However, from the viewpoint of gloss on a photo paper, the DBP oil absorption of the carbon black is preferably from 30 to 100 ml/100 g and especially preferably from 30 to 70 ml/100 g.

The volatile matter content of the carbon black is preferably 8 percent by weight or less, and especially preferably 4 percent by weight or less.

From the viewpoint of storage stability of the recording liquid, a pH is preferably 3 or more, and especially preferably 6 or more, and the upper limit thereof is preferably 11 or less, and especially preferably 9 or less.

The BET specific surface area of the carbon black is generally 100 m²/g or more, and preferably 150 m²/g or more, and the upper limit thereof is preferably 700 m²/g or less, and especially preferably 600 m²/g or less.

Herein, the DBP oil absorption is a value measured according to the method A specified in Japanese Industrial Standards (JIS) K6221A, the volatile matter content is a value measured according to the method specified in JIS K6221, the pH is a value of a mixture of the carbon black and distilled water measured with a glass-electrode meter, and the BET specific surface area is a value measured according to the method specified in JIS K6217.

From the viewpoint of safety, it is preferred to use a carbon black whose polycyclic aromatic components have been reduced by firing at temperatures of from 600° C. to 1500° C. or by washing typically with water, hot water, or a solvent. Among these procedures, firing at high temperatures is preferred, because functional groups on the surface of the carbon black are removed, whereby the dispersing agent is more efficiently and more firmly adsorbed on the surface of the carbon black.

Specific examples of the carbon black include commercial products 1) to 4) below.

1) #2700B, #2650, #2650B, #2600, #2600B, 2450B, 2400B, #2350, #2300, #2300B, #2200B, #1000, #1000B, #990, #990B, #980, #980B, #970, #960, #960B, #950, #950B, #900, #900B, #850, #850B, MCF88, MCF88B, MA600, MA600B, #750B, #650B, #52, #52B, #50, #47, #47B, #45, #45B, #45L, #44, #44B, #40, #40B, #33, #33B, #32, #32B, #30, #30B, #25, #25B, #20, #20B, #10, #10B, #5, #5B, CF9, CF9B, #95, #260, MA77, MA77B, MA7, MA7B, MA8, MA8B, MA11, MA11B, MA100, MA100B, MA100R, MA100RB, MA100S, MA230, MA220, MA200RB, MA14, #3030B, #3040B, #3050B, #3230B, and #3350B (all of which are products supplied by Mitsubishi Chemical Corporation).
2) Monarch 1400, Black Pearls 1400, Monarch 1300, Black Pearls 1300, Monarch 1100, Black Pearls 1100, Monarch 1000, Black Pearls 1000, Monarch 900, Black Pearls 900, Monarch 880, Black Pearls 880, Monarch 800, Black Pearls 800, Monarch 700, Black Pearls 700, Black Pearls 2000, Vulcan XC72R, Vulcan XC72, Vulcan PA90, Vulcan 9A32, Mogul L, Black Pearls L, Regal 660R, Regal 660, Black Pearls 570, Black Pearls 520, Regal 400R, Regal 400, Regal 330R, Regal 330, Regal 300R, Black Pearls 490, Black Pearls 480, Black Pearls 470, Black Pearls 460, Black Pearls 450, Black Pearls 430, Black Pearls 420, Black Pearls 410, Regal 350R, Regal 350, Regal 250R, Regal 250, Regal 99R, Regal 99I, Elftex Pellets 115, Elftex 8, Elftex 5, Elftex 12, Monarch 280, Black Pearls 280, Black Pearls 170, Black Pearls 160, Black Pearls 130, Monarch 120, and Black Pearls 120 (all of which are products supplied by Cabot Corporation).
3) Color Black FW1, Color Black FW2, Color Black FW2V, Color Black FW18, Color Black FW200, Special Black 4, Special Black 4A, Special Black 5, Special Black 6, Color Black S160, Color Black S170, Printex U, Printex V, Printex 150T, Printex 140U, Printex 140V, Printex 95, Printex 90, Printex 85, Printex 80, Printex 75, Printex 55, Printex 45, Printex 40, Printex P, Printex 60, Printex XE, Printex L6, Printex L, Printex 300, Printex 30, Printex 3, Printex 35, Printex 25, Printex 200, Printex A, Printex G, Special Black 550, Special Black 350, Special Black 250, and Special Black 100 (all of which are products supplied by Degussa (Evonik Industries AG)).
4) Raven 7000, Raven 5750, Raven 5250, Raven 5000 ULTRA, Raven 3500, Raven 2000, Raven 1500, Raven 1255, Raven 1250, Raven 1200, Raven 1170, Raven 1060 ULTRA, Raven 1040, Raven 1035, Raven 1020, Raven 1000, Raven 890H, Raven 890, Raven 850, Raven 790 ULTRA, Raven 760 ULTRA, Raven 520, Raven 500, Raven 450, Raven 430, Raven 420, Raven 410, CONDUCTEX 975 ULTRA, CONDUCTEX SC ULTRA, Raven H2O, and Raven C ULTRA (all of which are products supplied by Columbian Chemicals Corporation).

Each of these pigments may be used alone or two or more of them may be used in combination as the pigments for use in the present invention. Any other coloring materials may be used in combination with the pigments.

### [Aqueous Media]

Water and/or a water-soluble organic solvent may be used as an aqueous medium in the aqueous pigment dispersion according to the present invention. The water-soluble organic solvent is not especially limited, as long as being generally used in these uses. Specifically, ones having a vapor pressure lower than that of water are useful. Examples thereof include polyhydric alcohols such as ethylene glycol, propylene glycol, butanediol, pentanediol, 2-butene-1,4-diol, 2-methyl-2,4-pentanediol, 1,2,6-hexanetriol, diethylene glycol, triethylene glycol, poly(ethylene glycol), glycerol, and dipropylene glycol; ketones such as acetonylacetone; esters such as γ-butyrolactone, diacetin, and triethyl phosphate; lower alkoxyalcohols such as 2-methoxyethanol and 2-ethoxyethanol; as well as furfuryl alcohol, tetrahydrofurfuryl alcohol, N-methylpyrrolidone, N-ethylpyrrolidone, 1,3-dimethylimidazolidinone, thiodiethanol, thiodiglycol, dimethyl sulfoxide, ethylene glycol monoallyl ether, ethylene glycol monoethyl ether, ethylene glycol monobutyl ether, diethylene glycol monomethyl ether, triethylene glycol monobutyl ether, 2-pyrrolidone, sulfolane, imidazole, methylimidazole, hydroxyimidazole, triazole, nicotinamide, dimethylaminopyridine, ε-caprolactam, lactamide, 1,3-propane sultone, methyl carbamate, ethyl carbamate, 1-methylol-5,5-dimethylhydantoin, hydroxyethylpiperazine, piperazine, ethylene urea, propylene urea, urea, thiourea, biuret, semicarbazide, ethylene carbonate, propylene carbonate, acetamide, formamide, dimethylformamide, N-methylformamide, dimethylacetamide, and trimethylolpropane.

As the aqueous medium, water or a mixture of water and a water-soluble organic solvent is preferred.

### [Particle Diameter of Pigment in Dispersion and Other Factors]

Though the primary particle size of the pigment in the aqueous pigment dispersion according to the present invention may be arbitrarily set according to the intended purpose, it is generally 10 nm or more and 800 nm or less, and is preferably 500 nm or less, more preferably 300 nm or less, furthermore preferably 200 nm or less, and especially preferably 100 nm or less.

As used herein the “primary particle diameter” of the particle refers to an arithmetical average (number-average) diameter as measured with an electron microscope.

The average particle diameter of dispersed particles of the pigment in the dispersion is generally 500 nm or less, and preferably 200 nm or less. Its lower limit is generally 10 nm or more.

As a process for measuring the average particle diameter, a measurement using an electron microscope such as SEM or TEM, or a measurement using a commercially available dynamic light scattering measuring instrument can be employed.

The viscosity of the aqueous pigment dispersion according to the present invention is desirably lower from the viewpoint of discharge from an ink-jet head, and it is preferably 20 cp or less, and more preferably 10 cp or less in terms of viscosity of an aqueous pigment dispersion at a pigment concentration of 8 percent by weight.

The pH of the aqueous pigment dispersion according to the present invention is generally in the neutral to alkaline range, and preferably adjusted to a pH of from 7 to 9, for ensuring the stability of the dispersion and for maintenance of the printer body. Though being not limitative, a pH adjuster such as sodium hydroxide, nitric acid, or ammonia and/or a buffer such as phosphoric acid may be incorporated for adjusting the pH.

Preferred contents of the pigment, hydrophobic-group-containing cationic polymer, and hydrophobic-group-containing anionic polymer to be contained in the aqueous pigment dispersion according to the present invention are as will be described in the description of the after-mentioned method for producing the aqueous pigment dispersion according to the present invention.

It is enough for the aqueous pigment dispersion according to the present invention to contain at least the hydrophobic-group-containing cationic polymer and hydrophobic-group-containing anionic polymer as polymer components, but it may further contain any other polymer(s). In this case, the other polymer is not especially limited, and one or more types of polymers having hydrophobic monomer structural units (hydrophobic polymers) and polymers having nonionic hydrophilic monomer structural units and hydrophobic monomer structural units (water-soluble nonionic groups and hydrophobic groups) can be used.

### 2. Method for Producing Aqueous Pigment Dispersion

A method for producing the aqueous pigment dispersion according to the present invention is not especially limited, but the dispersion is preferably produced by a method for producing an aqueous pigment dispersion, according to the present invention, in which a pigment is dispersed by the action of a hydrophobic-group-containing cationic polymer; an excess of the polymer is then removed through ultrafiltration and/or microfiltration; and a hydrophobic-group-containing anionic polymer is added thereto.

### [Dispersion of Pigment by Hydrophobic-Group-Containing Cationic Polymer]

To disperse a pigment by the action of a hydrophobic-group-containing cationic polymer, predetermined amounts of the polymer and the pigment are dispersed in an aqueous medium mainly containing water using a common or general disperser. As a disperser used for carrying out the dispersing process, various types of dispersers which are usually used for dispersing pigments can be properly used.

The dispersers are not especially limited, and examples of usable dispersers include paint shaker, ball mill, sand mill, attritor, pearl mill, Co-ball mill, homomixer, homogenizer, wet type jet mill, and ultrasonic homogenizer. Exemplary media, if used in the disperser, include glass beads, zirconia beads, alumina beads, magnetic beads, and styrene beads. Of these, a preferred dispersing process is a process of carrying out dispersing using beads as media in a mill and then carrying out dispersing in an ultrasonic homogenizer.

The way to obtain an aqueous pigment dispersion with preferred particle diameters is not especially limited, but examples thereof include techniques or suitable combinations of them, such as reducing the size of dispersion media used in the disperser, increasing the packing ratio of the dispersion media, increasing the concentration of the pigment in the dispersion, and lengthening the time for the dispersing process.

If unfavorable phenomena occur such as the increasing of the viscosity of the dispersion or the foaming of the dispersion caused by the heat generated at the time of dispersing, it is desirable to carry out the dispersing process with cooling.

The amount of the hydrophobic-group-containing cationic polymer for the dispersing of the pigment is preferably from about 1 to about 500 parts by weight, and more preferably from 10 to 200 parts by weight, per 100 parts by weight of the pigment. If the amount of the polymer is excessively small, the dispersing of pigment in the aqueous medium becomes unstable to cause coagulation. In contrast, an extremely large amount of the polymer is also undesirable to cause the increase of viscosity of the dispersion and instability of the dispersion, because the amount of the polymer to be adsorbed on the pigment has a ceiling due typically to the hydrophile-hydrophobe balance, total surface area of the pigment particles, and the affinity between the hydrophobic groups and the surface of the pigment.

### [Ultrafiltration/Microfiltration Membrane (Removal of Free Hydrophobic-Group-Containing Cationic Polymer)]

The filtration step is carried out in order to remove free polymers from a dispersion obtained in the dispersing step. In a preferred embodiment, ultrafiltration, or microfiltration, or both in combination is carried out. If the filtration step is omitted, gelation and thickening (increase of viscosity) are likely to occur when a hydrophobic-group-containing anionic polymer is added in the subsequent step; and undesirable (unintended) polymer microparticles composed of no pigment but a hydrophobic-group-containing cationic polymer and a hydrophobic-group-containing anionic polymer alone are formed, whereby causing decrease of dispersion stability, unsatisfactory discharge properties, and decrease of gloss.

The filtration using an ultrafilter membrane or microfilter membrane is optimally carried out according to a crossflow filtration process. An exemplary specific process is a process in which the resulting aqueous pigment dispersion obtained in the step of dispersing by the action of the hydrophobic-group-containing cationic polymer is fed and circulated with a pump, and a suitable flow rate is given in a direction perpendicular to the plane of filtration, to thereby allow free polymers to permeate to the filtrate side. In this process, whether the hydrophobic-group-containing cationic polymer permeates or not can be determined typically based on the electroconductivity of the permeate.

The material of the ultrafilter membrane or microfilter membrane to be used is not especially limited and can be any of known materials. Examples of organic membranes include those composed of cellulose acetate, polysulfones, poly(ether sulfone)s, poly(phenylene sulfide)s, polyethylenes, polytetrafluoroethylene, polypropylenes, polyacrylonitriles, polyimides, and poly(vinyl alcohol)s; and examples of inorganic membranes include those composed of alumina, zirconia, and titania.

The molecular cutoff of the ultrafilter membrane may be suitably selected according to the molecular weight of a polymer to be removed, and in the present invention, it is preferably 3000 or more, and more preferably 6000 or more.

The pore size of the microfilter membrane may be suitably selected according to the size of dispersed pigment particles, and in the present invention, it is preferably 300 nm or less, more preferably 200 nm or less, and furthermore preferably 100 nm or less. With an increasing pore size, the proportion of permeated pigment particles increases and thereby the amount of recovered pigment particles markedly decreases, thus being undesirable.

The concentration of total solids, including the pigment and hydrophobic-group-containing cationic polymer, of the mixture obtained in the filtration step is preferably 1 percent by weight or more and 60 percent by weight or less, more preferably 3 percent by weight or more and 50 percent by weight or less, and furthermore preferably 5 percent by weight or more and 40 percent by weight or less. If the solid concentration is excessively low, the amount of filtrate may be excessively large, and the filtration efficiency may be impaired; in contrast, if it is excessively high, the membrane may often suffer from clogging, thus being undesirable.

It is enough for the temperature and pH in the ultrafiltration/microfiltration to be within such ranges that the membrane to be used can be applied and that the dispersion stability can be maintained. Though not especially limited, the temperature is preferably from 10° C. to 60° C., and more preferably from 15° C. to 40° C. The pH is preferably from 2 to 8, and more preferably from 3 to 7.

### [Addition of Hydrophobic-Group-Containing Anionic Polymer]

The adsorption of a hydrophobic-group-containing anionic polymer onto the pigment in the mixture (dispersion) after the filtration step may be carried out typically by mixing a predetermined amount of the polymer with the dispersion after the filtration step, which contains pigment particles adsorbing the hydrophobic-group-containing cationic polymer, and carrying out dispersing with a device of every kind which is generally used in mixing of solutions. Exemplary usable devices include, but are not limited to, homomixer, homogenizer, wet type jet mill, magnetic stirrer, and ultrasonic disperser. Among them, especially preferred as a dispersing device is an ultrasonic disperser.

The total number of dissociated ionic groups in the whole hydrophobic-group-containing anionic polymer to be added to the dispersion after the filtration step is preferably more than 1.0 time, and more preferably more than times the total number of dissociated ionic groups in the whole hydrophobic-group-containing cationic polymer adsorbed on the surfaces of pigment particles. If the amount of the former polymer is smaller than this range, the pigment may become unstably dispersed in the aqueous medium and may undergo coagulation. If the amount of the polymer is excessively large, the amount of free polymer that is not adsorbed on the pigment may increase, and this may cause the dispersion to have an increased viscosity or to be unstable in dispersing. Thus, the amount of the polymer is preferably such that the polymer has a number of anionic groups 10 times or less the total number of cationic groups adsorbed on the surfaces of pigment particles.

The amount of the hydrophobic-group-containing anionic polymer to be added is preferably determined according to the total number of actually dissociated ionic groups, because all the ionic groups in such polymer are not generally dissociated.

In the present invention, other polymers such as hydrophobic polymers other than the hydrophobic-group-containing cationic polymer and the hydrophobic-group-containing anionic polymer, and polymers having a water-soluble nonionic group and a hydrophobic group may be incorporated. In this case, of these polymers, the hydrophobic polymer is preferably added before the addition of the hydrophobic-group-containing anionic polymer; and the polymer having a water-soluble nonionic group and a hydrophobic group, for example, is preferably added simultaneously with or after the addition of the hydrophobic-group-containing anionic polymer.

A part of the hydrophobic-group-containing anionic polymer after the addition to the dispersion and after the dispersing process exists as a free polymer that is not adsorbed on the pigment, and such free polymer causes the dispersion to have an increased viscosity or to become unstable, and it also causes decrease in discharge properties and gloss. The free polymer is therefore preferably removed by filtration after the addition and dispersing of the hydrophobic-group-containing anionic polymer. In this case, it is desirable to remove the free polymer through ultrafiltration or microfiltration, or both in combination after the addition and dispersing of the hydrophobic-group-containing anionic polymer. The ultrafiltration/microfiltration herein can be carried out according to the same procedure as in the filtration for removing the free hydrophobic-group-containing cationic polymer, and the material, molecular cutoff, and pore size of an ultrafilter membrane/microfilter membrane to be used are also as above.

### 3. Total Solid Concentration, Pigment Content, and Other Parameters of Aqueous Pigment Dispersion

The total solids concentration in the aqueous pigment dispersion according to the present invention, preferably one produced by the method according to the present invention, is 0.1 percent by weight or more and 50 percent by weight or less, more preferably 1 percent by weight or more and 40 percent by weight or less, and furthermore preferably 5 percent by weight or more and 30 percent by weight or less. The total solids concentration is a concentration of solids including the pigment, the hydrophobic-group-containing cationic polymer, the hydrophobic-group-containing anionic polymer, and other polymers. If the solid concentration is excessively low, a sufficient pigment concentration may not be ensured in the preparation of a recording liquid; and in contrast, if it is excessively high, the viscosity may increase and the dispersion stability of the dispersion may decrease.

The content of the pigment is preferably 51 percent by weight or more based on the solids content in the aqueous pigment dispersion. It is more preferably 53 percent by weight or more, and furthermore preferably 55 percent by weight or more. The upper limit of the pigment content based on the total solids content in the aqueous pigment dispersion is not especially limited, but is preferably 90 percent by weight or less, and more preferably 80 percent by weight or less. If the pigment content based on the total solids content in the aqueous pigment dispersion is excessively large, the dispersing may become unstable, the thermal stability may deteriorate, and, in addition, the gloss may significantly decrease. If the pigment content based on the total solids content in the aqueous pigment dispersion is excessively small, polymers may exist in excess to the pigment, and part of these polymers may exist as being unabsorbed or in a state where they are dissociated from the surface of the pigment, thus the thermal stability and discharge stability may deteriorate.

The content of one or more other polymers, if contained in the aqueous pigment dispersion according to the present invention, than the hydrophobic-group-containing cationic polymer and the hydrophobic-group-containing anionic polymer is preferably 5 percent by weight or less. Specifically, the incorporation of other polymers such as hydrophobic polymers helps to increase the amount of polymers covering the pigment to thereby increase the gloss of a print. However, the incorporation, if in excessively large amounts, may increase the hydrophobicity of the surface of the pigment, whereby the dispersion stability may decrease.

### 4. Recording Liquids

The aqueous pigment dispersion according to the present invention is usable as a coloring agent component in recording liquids, and is especially preferably used in ink-jet recording liquids

A recording liquid according to the present invention may be prepared by adjusting, according to necessity, the concentration of coloring agent in the aqueous pigment dispersion according to the present invention, and adding various additives depending on the intended use.

The recording liquid may further contain additional coloring agents for the purpose typically of toning, in addition to the pigment contained in the aqueous pigment dispersion according to the present invention. Exemplary other coloring agents include self-dispersible pigments and dyes whose surface has been treated, and pigments and dyes dispersed by the action typically of a surfactant or a polymer dispersing agent.

The concentration of total coloring agents in the recording liquid according to the present invention is preferably 0.1 percent by weight or more, and more preferably 0.5 percent by weight or more, and the upper limit thereof is preferably 20 percent by weight or less, more preferably 15 percent by weight or less, and especially preferably 10 percent by weight or less, based on the total amount of the recording liquid. If the concentration of coloring agents is excessively high, the viscosity may increase and the discharge properties may deteriorate. In contrast, if it is excessively low, the optical density may become excessively low. On the other hand, the amount of additional coloring agents further incorporated to the aqueous pigment dispersion is generally 100 parts by weight or less, preferably 75 parts by weight or less, more preferably 50 parts by weight or less, and especially preferably 25 parts by weight or less, per 100 parts by weight of the pigment in the aqueous pigment dispersion. If the amount of additional coloring agents is excessively large, advantages of the present invention may decrease.

A solvent for use in the recording liquid according to the present invention preferably contains water and a water-soluble organic solvent and, if desired, may further contain other components.

The concentration of the water-soluble organic solvent in the recording liquid according to the present invention may be selected and set as appropriate, but it is generally 1 percent by weight or more and 45 percent by weight or less, and especially preferably 40 percent by weight or less, based on the total amount of the recording liquid. Furthermore, the content of water in the recording liquid may be such a content that concentrations of the coloring agent and water-soluble organic solvent and arbitrary additional components (additives) as described below can be properly set up.

The water-soluble organic solvent is not especially limited, as long as being one generally used in this intended use. Specifically, ones having a vapor pressure lower than that of water are useful. Examples thereof include polyhydric alcohols such as ethylene glycol, propylene glycol, butanediol, pentanediol, hexanediol, 2-ethyl-1,3-hexanediol, 2-amino-2-ethyl-1,3-propanediol, 2-butene-1,4-diol, 2-methyl-2,4-pentanediol, 1,2,6-hexanetriol, diethylene glycol, triethylene glycol, poly(ethylene glycol), glycerol, and dipropylene glycol; ketones such as acetonylacetone; esters such as γ-butyrolactone, diacetin, and triethyl phosphate; lower alkoxyalcohols such as 2-methoxyethanol and 2-ethoxyethanol; as well as furfuryl alcohol, tetrahydrofurfuryl alcohol, N-methylpyrrolidone, N-ethylpyrrolidone, 1,3-dimethylimidazolidinone, thiodiethanol, thiodiglycol, dimethyl sulfoxide, ethylene glycol monoallyl ether, ethylene glycol monoethyl ether, ethylene glycol monobutyl ether, diethylene glycol monomethyl ether, diethylene glycol monoethyl ether, diethylene glycol-n-hexyl ether, triethylene glycol monobutyl ether, propylene glycol propyl ether, dipropylene glycol propyl ether, 2-pyrrolidone, sulfolane, imidazole, methylimidazole, hydroxyimidazole, triazole, nicotinamide, dimethylaminopyridine, ε-caprolactam, lactamide, 1,3-propane sultone, methyl carbamate, ethyl carbamate, 1-methylol-5,5-dimethylhydantoin, hydroxyethylpiperazine, piperazine, ethylene urea, propylene urea, urea, thiourea, biuret, semicarbazide, ethylene carbonate, propylene carbonate, acetamide, formamide, dimethylformamide, N-methylformamide, dimethylacetamide, and trimethylolpropane. Each of these may be used alone or two or more of them may be used in combination.

The recording liquid according to the present invention may further contain a variety of additives according to necessity, within ranges not adversely affecting the advantages of the present invention.

Examples of such additives include additives known for use in recording liquids, such as permeation accelerators, surfactants, surface tension modifiers, hydrotropic agents, pH adjusters, chelating agents, preservatives, viscosity adjusters, humectants, fungicides, and rust preventives.

The total content of these additives in the recording liquid according to the present invention is generally 30 percent by weight or less, and especially preferably 20 percent by weight or less, based on the total amount of the recording liquid.

Exemplary permeation accelerators include lower alcohols such as ethanol, isopropanol, butanol, and pentanol; carbitols such as ethylene glycol monobutyl ether and triethylene glycol monobutyl ether glycol ether; and surfactants. One or more types of them may be used.

As surfactants, one or more types of arbitrary surfactants may be used, such as nonionic surfactants, anionic surfactants, cationic surfactants, amphoteric surfactants, and polymeric surfactants. Among them, nonionic surfactants, anionic surfactants, and polymeric surfactants are preferred.

Exemplary nonionic surfactants include polyoxyethylene alkyl ethers, polyoxyethylene alkyl aryl ethers, polyoxyethylene derivatives, oxyethylene/oxypropylene block copolymers, sorbitan fatty acid esters, polyoxyethylene sorbitan fatty acid esters, polyoxyethylene sorbitol fatty acid esters, glycerol fatty acid esters, polyoxyethylene fatty acid esters, and polyoxyethylene alkylamines.

Exemplary anionic surfactants include fatty acid salts, alkyl sulfuric ester salts, alkylbenzenesulfonic acid salts, alkylnaphthalenesulfonic acid salts, alkylsulfosuccinic acid salts, alkyl diphenyl ether sulfonic acid salts, alkyl phosphoric acid salts, polyoxyethylene alkyl sulfuric ester salts, polyoxyethylene alkyl aryl sulfuric ester salts, alkanesulfonic acid salts, naphthalenesulfonic acid-formalin condensates, polyoxyethylene alkyl phosphoric esters, and α-olefinsulfonic acid salts.

Exemplary polymeric surfactants include poly(acrylic acid)s, styrene/acrylic acid copolymers, styrene/acrylic acid/acrylic ester copolymers, styrene/maleic acid copolymers, styrene/maleic acid/acrylic ester copolymers, styrene/methacrylic acid copolymers, styrene/methacrylic acid/acrylic ester copolymers, styrene/maleic half ester copolymers, styrene/styrenesulfonic acid copolymers, vinylnaphthalene/maleic acid copolymers, vinylnaphthalene/acrylic acid copolymers, and salts of them.

Exemplary cationic surfactants include, but are not limited to, tetraalkylammonium salts, alkylamine salts, benzalkonium salts, alkylpyridinium salts, and imidazolium salts.

Examples of other surfactants usable herein include silicone surfactants such as polysiloxane oxyethylene adducts; fluorine surfactants such as perfluoroalkylcarboxylic acid salts, perfluoroalkylsulfonic acid salts, oxyethylene perfluoroalkyl ethers; and biosurfactants such as rhamnolipid and lysolecithin.

The content of such surfactants may be properly chosen and determined. Usually, by adding the surfactant in an amount in the range of 0.001 percent by weight or more and 5 percent by weight or less based on the total amount of the recording liquid, it is possible to further improve rapid dryness and printing quality of a print.

The surface tension modifier for use herein can be one or more members selected from alcohols such as diethanolamine, triethanolamine, glycerol, and diethylene glycol; and nonionic, cationic, anionic, or amphoteric surfactants.

As the hydrotropic agents, one or more of urea, alkylureas, ethylene urea, propylene urea, thiourea, guanidine salts, and tetraalkylammonium halides are preferred.

As the humectants, one or more types typically of glycerol and diethylene glycol can be added as one which also functions as a water-soluble organic solvent. In addition, one or more types of sugars such as maltitol, sorbitol, gluconolactone, and maltose can be added as humectants.

Though the chelating agents are not especially limited, one or more types typically of sodium ethylenediaminetetraacetate and diammonium ethylenediaminetetraacetate are usable. Such a material is preferably used in an amount within the range of 0.005 percent by weight or more and 0.5 percent by weight or less based on the total amount of the recording liquid.

Though the fungicides are not especially limited, one or more types typically of sodium dehydroacetate and sodium benzoate are usable. Such a material is preferably contained in an amount within the range of 0.05 percent by weight or more and 1 percent by weight or less based on the total amount of the recording liquid.

The recording liquid according to the present invention may further contain polymer microparticles for the purpose of further improving the fixing properties of an image to a recording medium and improving the rub fastness thereof. The polymer microparticles are not especially limited, but are preferably ones having ionic groups on their surface and having particle diameters of from 10 to 150 nm. Such polymer microparticles are preferably used in an amount within the range of 10 percent by weight or less based on the total amount of the recording liquid.

For the purposes of adjusting the pH of the recording liquid and stabilizing the recording liquid, a pH modifier such as sodium hydroxide, nitric acid, and ammonia, and/or a buffer such as phosphoric acid can also be used, although these materials are not especially limited.

The pH of the recording liquid is usually in the neutral to alkaline range. The recording liquid is preferably adjusted to a pH of from about 6 to 11.

### EXAMPLES

The present invention will be illustrated in further detail with reference to several Examples and Comparative Examples below. It should be noted, however, the present invention is not construed to be limited to these Examples, without departing from the scope and spirit thereof.

### Synthetic Example 1

### Synthesis of Hydrophobic-Group-Containing Cationic Polymer I: Poly(styrene-co-2-methacryloyloxyethyltrimethylammonium chloride)

A separable flask equipped with a condenser, a nitrogen inlet tube, a stirrer, and a thermometer, whose inside had been purged with nitrogen, was charged with 13.9 g of 2,2′-azobisisobutyronitrile as a catalyst. The flask was further charged with 2200.0 g of SOLMIX A-11 (a solvent mixture of percent by weight ethanol, 13.4 percent by weight methanol, and 1.1 percent by weight isopropyl alcohol, supplied by Japan Alcohol Trading Co., Ltd.) and 330.0 g of distilled water as solvents; 415.0 g of styrene and 442.0 g of ACRYESTER DMC (a 80 percent by weight aqueous solution of 2-methacryloyloxyethyltrimethylammonium chloride, supplied by Mitsubishi Rayon Co., Ltd.) as monomers; and 35.1 g of lauryl mercaptan as a chain-transfer agent.

The separable flask was immersed in an oil bath, the bath temperature was raised from room temperature to 78° C. over one hour, and a polymerization was carried out at 78° C. for 10 hours.

After the completion of the polymerization, the polymerization reaction mixture was concentrated under reduced pressure on an evaporator, and the concentrated polymerization reaction mixture was added dropwise to a solvent mixture of isopropanol/tetrahydrofuran (1/2 (v/v)) to precipitate the resulting polymer. The supernatant was removed by decantation, the residue was mixed with 5000.0 g of distilled water, the residual organic solvents were removed through atmospheric distillation, whereby an aqueous polymer solution was obtained. The resulting aqueous polymer solution was dried, and thereby yielded a poly(styrene-co-2-methacryloyloxyethyltrimethylammonium chloride): hydrophobic-group-containing cationic polymer I.

The structure of the resulting polymer was identified through ¹H-NMR using DMSO (dimethyl sulfoxide) as a solvent. The ¹H-NMR analysis revealed that the compositional ratio of styrene units to 2-methacryloyloxyethyltrimethylammonium chloride units in the hydrophobic-group-containing cationic polymer I was 70:30 (molar ratio). The polymer was found to have a number-average molecular weight (Mn) of 13000 and a molecular-weight distribution of 1.6 as measured through GPC (gel permeation chromatography).

### Production Example 1

### Preparation of Black Pigment Dispersion Containing Hydrophobic-Group-Containing Cationic Polymer I (Dispersion α)

To 28.0 g of a carbon black (#960, supplied by Mitsubishi Chemical Corporation) were added 81.7 g of an aqueous solution of the hydrophobic-group-containing cationic polymer I obtained in Synthetic Example 1 (with a concentration of the hydrophobic-group-containing cationic polymer I of 20.57 percent by weight) and 170.0 g of distilled water to give a mixture, the mixture was dispersed in a self-made bead mill with zirconia beads 0.5 mm in diameter as media at 25° C. for 4 hours, from which the beads were removed, the concentration of the pigment was adjusted to 8 percent by weight, and thereby yielded a dispersion (1).

The dispersion (1) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 40 minutes, and thereby yielded a pigment dispersion (2).

The dispersion (2) was diluted 2-fold with distilled water, from which free polymers were removed through a microfilter membrane (Spectrum Laboratories Inc: made of a polysulfone, with a pore size of 0.05 μm), the filtrate was concentrated, and thereby yielded a dispersion α having a pigment concentration of 8 percent by weight.

### Measurement of Chlorine Ion Concentration

The dispersion α was diluted 10-fold with distilled water, and 10.0 g of the diluted dispersion α was mixed with 0.20 g of an ionic strength adjuster (Thermo Electron Corporation: Cat. No. 940011) to give a mixture. A chlorine composite electrode (Thermo Electron Corporation: Model 9617) was mounted to an ion counter (Thermo Orion Corporation: Model 290Aplus), and measurement of the chlorine ion concentration of the mixture was carried out.

The chlorine ion concentration of the dispersion α was found to be 0.044 mol/L.

### Synthetic Example 2

### Synthesis of Hydrophobic-Group-Containing Anionic Polymer 1: Poly(isobornyl methacrylate-co-sodium acrylate)

A flask equipped with a condenser, a nitrogen inlet tube, a stirrer, and a thermometer, whose inside had been purged with nitrogen, was charged with 2.25 g of 2,2′-azobis(2,4-dimethylvaleronitrile) as a catalyst, and the flask was further charged with 262.5 g of tetrahydrofuran as a solvent; and 67.75 g of acrylic acid and 52.25 g of isobornyl methacrylate as monomers. The bath temperature was raised to 70° C. over one hour, followed by carrying out a polymerization reaction for 8 hours.

After the completion of the reaction, the reaction mixture was cooled to room temperature and added dropwise to acetonitrile, to give precipitates. The precipitates were collected, dried in vacuo, and thereby yielded a crude polymer. The crude polymer was combined with ion-exchanged water, neutralized with a 5 N aqueous sodium hydroxide solution, and thereby yielded an aqueous solution. After removing impurities therefrom through microfiltration, the aqueous polymer solution was concentrated and evaporated to dryness, and thereby yielded a poly(isobornyl methacrylate-co-sodium acrylate): hydrophobic-group-containing anionic polymer 1.

The structure of the resulting polymer was identified through ¹³C-NMR. The ¹³C-NMR analysis revealed that the polymer had a compositional ratio of isobornyl methacrylate units to sodium acrylate units of 21:79 (molar ratio). The polymer was found to have a number-average molecular weight (Mn) of 5800 and a molecular-weight distribution of 1.6, as determined through GPC.

### Measurement of Sodium Ion Concentration of Hydrophobic-Group-Containing Anionic Polymer 1

An aqueous solution of the hydrophobic-group-containing anionic polymer 1 (13.67 percent by weight) was diluted 10-fold with distilled water, and 10.0 g of the diluted solution was combined with 1 g of an ionic strength adjuster (Thermo Orion Corporation: Cat. No. 841111) to give a mixture. A sodium composite electrode (Thermo Orion Corporation: Model 8611 BN ROSS™) was mounted to an ion counter (Thermo Orion Corporation: Model 290Aplus), and the sodium ion concentration of the mixture was measured.

The sodium ion concentration of an aqueous solution (13.67 percent by weight) of the hydrophobic-group-containing anionic polymer 1 was found to be 0.81 mol/L.

### Production Example 2

### Preparation of Black Pigment Dispersion Containing Hydrophobic-Group-Containing Cationic Polymer I and Hydrophobic-Group-Containing Anionic Polymer 1 (Dispersion A)

To 70 g of the dispersion α was added 90 g of distilled water to give a diluted dispersion. Independently, 20.14 g of an aqueous solution of the hydrophobic-group-containing anionic polymer 1 (with a concentration of the hydrophobic-group-containing anionic polymer 1 of 13.67 percent by weight) was diluted with 99.86 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 20 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion A having a pigment concentration of 8 percent by weight. The dispersion A had a pigment content based on its solids content of 61.7 percent by weight.

The ratio of the number of cationic groups in the hydrophobic-group-containing cationic polymer I to the number of anionic groups in the hydrophobic-group-containing anionic polymer 1 both contained in the resulting dispersion A (hereinafter referred to as “C/A ratio”) was determined according to the following technique and found to be 1/3.6.

### Technique for Determining C/A Ratio of Dispersion A

The dispersion A had a non-volatile components content of 12.97 percent by weight, as measured by heating the dispersion A at 180° C. for 90 minutes, and had a pigment concentration of 8 percent by weight. Accordingly, the ratio of the pigment to the polymers in the dispersion A was calculated to be 61.7/38.3 (percent by weight). Independently, nitrogen contents of the hydrophobic-group-containing cationic polymer I, of the carbon black (supplied by Mitsubishi Chemical Corporation: #960), and of the non-volatile components of the dispersion A were measured through organic element analyses and found to be 3.43 percent by weight, 0.072 percent by weight, and 0.60 percent by weight, respectively. Herein a value obtained by subtracting the amount of nitrogen derived from the carbon black from the amount of nitrogen in the non-volatile components of the dispersion A was defined as the amount of nitrogen derived from the hydrophobic-group-containing cationic polymer I. Thus, the content of the hydrophobic-group-containing cationic polymer I in the non-volatile components of the dispersion A was calculated to be 16.2 percent by weight; and a value obtained by subtracting this value from the content of the polymer was defined as the content of the hydrophobic-group-containing anionic polymer 1 (i.e., 38.3 percent by weight minus 16.2 percent by weight equals 22.1 percent by weight). A C/A ratio was calculated from the abundance ratio between the hydrophobic-group-containing cationic polymer I and the hydrophobic-group-containing anionic polymer 1 using the compositional ratio of the respective polymers determined by NMR and found to be 1/3.6.

### Synthetic Example 3

### Synthesis of Hydrophobic-Group-Containing Anionic Polymer 2: Poly(isobornyl methacrylate-co-sodium acrylate)

A flask equipped with a condenser, a nitrogen inlet tube, a stirrer, and a thermometer, whose inside had been purged with nitrogen, was charged with 0.28 g of 2,2′-azobis(2,4-dimethylvaleronitrile) as a catalyst, and the flask was further charged with 164.0 g of tetrahydrofuran as a solvent; 84.68 g of acrylic acid and 65.32 g of isobornyl methacrylate as monomers. The bath temperature was raised to 70° C. over one hour, followed by carrying out a polymerization reaction for 5 hours.

After the completion of the reaction, the reaction mixture was cooled to room temperature and added dropwise to acetonitrile to give precipitates. The precipitates were collected, dried in vacuo, and thereby yielded a crude polymer. The crude polymer was combined with ion-exchanged water, neutralized with a 5 N aqueous sodium hydroxide solution, and thereby yielded an aqueous solution. After removing impurities therefrom through microfiltration, the aqueous polymer solution was concentrated and evaporated to dryness, and thereby yielded a poly(isobornyl methacrylate-co-sodium acrylate): hydrophobic-group-containing anionic polymer 2.

The structure of the resulting polymer was identified through ¹³C-NMR. The ¹³C-NMR analysis revealed that the polymer had a compositional ratio of isobornyl methacrylate units to sodium acrylate units of 19:81 (molar ratio). The polymer was found to have a number-average molecular weight (Mn) of 12000 and a molecular-weight distribution of 1.7, as determined through GPC.

### Measurement of Sodium Ion Concentration of Hydrophobic-Group-Containing Anionic Polymer 2

The sodium ion concentration of an aqueous solution (10.54 percent by weight) of the hydrophobic-group-containing anionic polymer 2 was found to be 0.63 mol/L, as measured by the procedure of Synthetic Example 2.

### Production Example 3

### Preparation of Black Pigment Dispersion Containing Hydrophobic-Group-Containing Cationic Polymer I and Hydrophobic-Group-Containing Anionic Polymer 2 (Dispersion B)

To 70 g of the dispersion α was added 90 g of distilled water to give a diluted dispersion. Independently, 24.39 g of an aqueous solution of the hydrophobic-group-containing anionic polymer 2 (with a concentration of the hydrophobic-group-containing anionic polymer 2 of 10.54 percent by weight) with 95.61 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion B having a pigment concentration of 8 percent by weight. The dispersion B had a pigment content based on its solids content of 66.1 percent by weight.

The C/A ratio of the resulting dispersion B was determined by the procedure of Production Example 2 and found to be 1/2.8.

### Synthetic Example 4

### Synthesis of Hydrophobic-Group-Containing Anionic Polymer 3: Poly(styrene-co-sodium Itaconate)

A flask equipped with a condenser, a nitrogen inlet tube, a stirrer, and a thermometer, whose inside had been purged with nitrogen, was charged with 0.58 g of 2,2′-azobis(2,4-dimethylvaleronitrile) as a catalyst, and the flask was further charged with 180 g of methanol as a solvent, 56.5 g of styrene and 143.4 g of itaconic acid as monomers. The bath temperature was raised from room temperature to 60° C. to completely dissolve the solid itaconic acid, the bath temperature was further raised to 69° C., followed by carrying out a polymerization reaction for 8 hours.

After the completion of the reaction, the reaction mixture was cooled to room temperature, neutralized by adding 440.8 g of a 10 percent by weight sodium hydroxide solution in methanol with stirring, combined with distilled water while removing methanol on an evaporator, and thereby yielded an aqueous crude polymer solution. After removing impurities from the aqueous crude polymer solution through ultrafiltration, the resulting aqueous polymer solution was concentrated and evaporated to dryness, and thereby yielded a poly(styrene-co-sodium itaconate): hydrophobic-group-containing anionic polymer 3.

The structure of the resulting polymer was identified through ¹H-NMR using DMSO as a solvent. The ¹H-NMR analysis revealed that the polymer had a compositional ratio of styrene units to sodium itaconate units of 45/55 (molar ratio). The polymer was found to have a number-average molecular weight (Mn) of 14000 and a molecular-weight distribution of 1.7, as determined through GPC.

Measurement of Sodium Ion Concentration of Hydrophobic-Group-Containing Anionic Polymer 3

The sodium ion concentration of an aqueous solution percent by weight) of the hydrophobic-group-containing anionic polymer 3 was found to be 0.70 mol/L, as measured by the procedure of Synthetic Example 2.

### Production Example 4

### Preparation of Black Pigment Dispersion Containing Hydrophobic-Group-Containing Cationic Polymer I and Hydrophobic-Group-Containing Anionic Polymer 3 (Dispersion C)

To 70 g of the dispersion α was added 90 g of distilled water to give a diluted dispersion. Independently, 24.69 g of an aqueous solution of the hydrophobic-group-containing anionic polymer 3 (with a concentration of the hydrophobic-group-containing anionic polymer 3 of 12.74 percent by weight) was diluted with 95.31 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 90 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion C having a pigment concentration of 8 percent by weight. The dispersion C had a pigment content based on its solids content of 66.7 percent by weight.

The C/A ratio of the resulting dispersion C was determined by the procedure of Production Example 2 and found to be 1/4.5.

### Synthetic Example 5

### Synthesis of Hydrophobic-Group-Containing Anionic Polymer 4: Poly(cyclohexyl methacrylate-co-sodium Acrylate)

A flask equipped with a condenser, a nitrogen inlet tube, a stirrer, and a thermometer, whose inside had been purged with nitrogen, was charged with 2.25 g of 2,2′-azobis(2,4-dimethylvaleronitrile) as a catalyst, and the flask was further charged with 262.5 g of tetrahydrofuran as a solvent; and 59.98 g of acrylic acid and 60.02 g of cyclohexyl methacrylate as monomers. The bath temperature was raised to 70° C. over one hour, followed by carrying out a polymerization reaction for 8 hours.

After the completion of the reaction, the reaction mixture was cooled to room temperature and concentrated by evaporation. The concentrated reaction mixture was added dropwise to acetonitrile to give precipitates. The precipitates were collected, dried in vacuo, and thereby yielded a crude polymer. The crude polymer was combined with ion-exchanged water, neutralized with a 5 N aqueous sodium hydroxide solution, and thereby yielded an aqueous solution. After removing impurities therefrom through microfiltration, the aqueous polymer solution was concentrated and evaporated to dryness, and thereby yielded a poly(cyclohexyl methacrylate-co-sodium acrylate): hydrophobic-group-containing anionic polymer 4.

The structure of the resulting polymer was identified through ¹H-NMR. The ¹H-NMR analysis revealed that the polymer had a compositional ratio of cyclohexyl methacrylate units to sodium acrylate units of 45:55 (molar ratio). The polymer was also found to have a number-average molecular weight (Mn) of 11000 and a molecular-weight distribution of 1.4, as determined through GPC.

### Measurement of Sodium Ion Concentration of Hydrophobic-Group-Containing Anionic Polymer 4

The sodium ion concentration of an aqueous solution (16.88 percent by weight) of the hydrophobic-group-containing anionic polymer 4 was determined by the procedure of Synthetic Example 2 and found to be 0.88 mol/L.

### Production Example 5

### Preparation of Black Pigment Dispersion Containing Hydrophobic-Group-Containing Cationic Polymer I and Hydrophobic-Group-Containing Anionic Polymer 4 (Dispersion D)

To 70 g of the dispersion (a was added 90 g of distilled water to give a diluted dispersion. Independently, a diluted aqueous solution was prepared by diluting 18.54 g of an aqueous solution of the hydrophobic-group-containing anionic polymer 4 (with a concentration of the hydrophobic-group-containing anionic polymer 4 of 16.88 percent by weight) with 101.46 g of distilled water. The diluted aqueous solution was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 60 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion D having a pigment concentration of 8 percent by weight. The dispersion D had a pigment content based on its solids content of 62.3 percent by weight.

The C/A ratio of the resulting dispersion D was determined by the procedure of Production Example 2 and found to be 1/3.0.

### Synthetic Example 6

### Synthesis of Hydrophobic-Group-Containing Anionic Polymer 5: Poly(cyclohexyl methacrylate-co-sodium Acrylate)

A flask equipped with a condenser, a nitrogen inlet tube, a stirrer, and a thermometer, whose inside had been purged with nitrogen, was charged with 0.28 g of 2,2′-azobis(2,4-dimethylvaleronitrile) as a catalyst, and the flask was further charged with 164.0 g of tetrahydrofuran as a solvent; and 94.72 g of acrylic acid and 55.28 g of cyclohexyl methacrylate as monomers. The bath temperature was raised to 70° C. over one hour, followed by carrying out a polymerization reaction for 5 hours.

After the completion of the reaction, the reaction mixture was cooled to room temperature, diluted with tetrahydrofuran, and added dropwise to acetonitrile to give precipitates. The precipitates were collected, dried in vacuo, and thereby yielded a crude polymer. The crude polymer was combined with ion-exchanged water, neutralized with a 5 N aqueous sodium hydroxide solution, and thereby yielded an aqueous solution. After removing impurities therefrom through microfiltration, the aqueous polymer solution was concentrated and evaporated to dryness, and thereby yielded a poly(sodium acrylate-co-cyclohexyl methacrylate): hydrophobic-group-containing anionic polymer 5.

The structure of the resulting polymer was identified through ¹H-NMR. The ¹H-NMR analysis revealed that the polymer had a compositional ratio of sodium acrylate units to cyclohexyl methacrylate units of 33:67 (molar ratio). The polymer was also found to have a number-average molecular weight (Mn) of 26000 and a molecular-weight distribution of 1.8 as determined through GPC.

### Measurement of Sodium Ion Concentration of Hydrophobic-Group-Containing Anionic Polymer 5

The sodium ion concentration of an aqueous solution (11.26 percent by weight) of the hydrophobic-group-containing anionic polymer 5 was determined by the procedure of Synthetic Example 2 and found to be 0.71 mol/L.

### Production Example 6

### Preparation of Black Pigment Dispersion Containing Hydrophobic-Group-Containing Cationic Polymer I and Hydrophobic-Group-Containing Anionic Polymer 5 (Dispersion E)

To 70 g of the dispersion α was added 90 g of distilled water to give a diluted dispersion. Independently, 22.23 g of an aqueous solution of the hydrophobic-group-containing anionic polymer 5 (with a concentration of the hydrophobic-group-containing anionic polymer 5 of 11.26 percent by weight) was diluted with 97.77 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 60 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion E having a pigment concentration of 8 percent by weight. The dispersion E had a pigment content based on its solids content of 75.5 percent by weight.

The C/A ratio of the resulting dispersion E was determined by the procedure of Production Example 2 and found to be 1/4.0.

### Synthetic Example 7

### Synthesis of Hydrophobic-Group-Containing Cationic Polymer II: Poly(styrene-co-2-methacryloyloxyethyltrimethylammonium Chloride)

A separable flask equipped with a condenser, a nitrogen inlet tube, a stirrer, and a thermometer, whose inside had been purged with nitrogen, was charged with 4.76 g of 2,2′-azobisisobutyronitrile as a catalyst. Next, the flask was further charged with 623.6 g of SOLMIX A-11 (a solvent mixture of 85.5 percent by weight ethanol, 13.4 percent by weight methanol, and 1.1 percent by weight isopropyl alcohol; supplied by Japan Alcohol Trading Co., Ltd.) and 97.0 g of distilled water as solvents; 97.0 g of styrene and 103.7 g of ACRYESTER DMC (a 80 percent by weight aqueous solution of 2-methacryloyloxyethyltrimethylammonium chloride; supplied by Mitsubishi Rayon Co., Ltd.) as monomers; and 4.76 g of 2-mercaptoethanol as a chain-transfer agent.

The separable flask was immersed in an oil bath, the bath temperature was raised from room temperature to 78° C. over 45 minutes, and a polymerization was carried out at 78° C. for 10 hours.

After the completion of the polymerization, the polymerization reaction mixture was concentrated to 2.5-fold on an evaporator under reduced pressure, and the concentrated polymerization reaction mixture was added dropwise to acetone to precipitate the resulting polymer. The supernatant was removed by decantation, the residue was combined with 1500 g of distilled water, from which the residual organic solvents were removed through atmospheric distillation, whereby an aqueous polymer solution was obtained. The resulting aqueous polymer solution was dried, and thereby yielded a poly(styrene-co-2-methacryloyloxyethyltrimethylammonium chloride): hydrophobic-group-containing cationic polymer II.

The structure of the resulting polymer was identified through ¹H-NMR using DMSO as a solvent. The hydrophobic-group-containing cationic polymer II was found to have a compositional ratio of styrene units to 2-methacryloyloxyethyltrimethylammonium chloride units of 70:30 (molar ratio) as calculated based on the NMR data. The polymer II was also found to have a number-average molecular weight of 7000 and a molecular-weight distribution of 1.3 as measured through GPC.

### Production Example 7

### Preparation of Black Pigment Dispersion Containing Hydrophobic-Group-Containing Cationic Polymer II (Dispersion A)

To 28.0 g of a fired carbon black (a fired product of #2300B supplied by Mitsubishi Chemical Corporation, fired at 1200° C. in a nitrogen atmosphere for one month; powder; solids content 100 percent by weight) were added 98.5 g of an aqueous solution of the hydrophobic-group-containing cationic polymer II (with a concentration of the hydrophobic-group-containing cationic polymer II of 17.1 percent by weight) and 153.5 g of deionized water to give a mixture. The mixture was preliminarily dispersed in a homomixer for 60 minutes and further dispersed in a self-made bead mill with zirconia beads 0.5 mm in diameter as media at 60° C. for 7 hours and further at 40° C. for one hour, from which the beads were removed, the concentration of the pigment was adjusted to 8 percent by weight, and thereby yielded a dispersion (3).

The dispersion (3) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 60 minutes, and thereby yielded a pigment dispersion (4).

The dispersion (4) was diluted 2-fold with distilled water, from which free polymers were removed through a microfilter membrane (Spectrum Laboratories Inc, made from a polysulfone, with a pore size of 0.05 em), the filtrate was concentrated, and thereby yielded a dispersion β having a pigment concentration of 8 percent by weight.

### Measurement of Chlorine Ion Concentration

The chlorine ion concentration of the dispersion K was measured by the procedure of Production Example 1 and found to be 0.050 mol/L.

### Synthetic Example 8

### Synthesis Of Hydrophobic-Group-Containing Anionic Polymer 6: Poly(isobornyl methacrylate-co-methoxypoly(ethylene glycol) acrylate-co-sodium acrylate)

A flask equipped with a condenser, a nitrogen inlet tube, a stirrer, and a thermometer, whose inside had been purged with nitrogen, was charged with 1875 g of tetrahydrofuran as a solvent; 301.72 g of isobornyl methacrylate, 654.90 g of a methoxypoly(ethylene glycol) acrylate (LIGHT-ACRYLATE 130A supplied by Kyoeisha Chemical Co., Ltd.), and 293.38 g of acrylic acid as monomers. The bath temperature was raised to 60° C., and 5.57 g of 2,2′-azobisisobutyronitrile as a catalyst was added, followed by carrying out a polymerization reaction for 5 hours. The bath temperature was further raised to 70° C., followed by carrying out a polymerization reaction for 2 hours.

After the completion of the reaction, the reaction mixture was cooled to room temperature, neutralized with a 5 N aqueous sodium hydroxide solution, combined with distilled water, from which tetrahydrofuran was distilled off with heating to give an aqueous crude polymer solution. After removing impurities from the aqueous crude polymer solution through ultrafiltration, the resulting aqueous polymer solution was concentrated and evaporated to dryness and thereby yielded a poly(isobornyl methacrylate-co-methoxypoly(ethylene glycol) acrylate-co-sodium acrylate): hydrophobic-group-containing anionic polymer 6.

The structure of the resulting polymer was identified through ¹H-NMR. The ¹H-NMR analysis revealed that the polymer had a compositional ratio of isobornyl methacrylate units to methoxypoly(ethylene glycol) acrylate units to sodium acrylate units of 26/20/54 (molar ratio). The polymer was also found to have a number-average molecular weight (Mn) of 12000 and a molecular-weight distribution of 1.9 as determined through GPC.

### Measurement of Sodium Ion Concentration of Hydrophobic-Group-Containing Anionic Polymer 6

The sodium ion concentration of an aqueous solution (12.99 percent by weight) of the hydrophobic-group-containing anionic polymer 6 was measured by the procedure of Synthetic Example 2 and found to be 0.36 mol/L.

### Production Example 8

### Preparation of Black Pigment Dispersion Containing Hydrophobic-Group-Containing Cationic Polymer II and Hydrophobic-Group-Containing Anionic Polymer 6 (Dispersion F)

To 65 g of the dispersion β was added dropwise 31.47 g of an aqueous dispersion of the hydrophobic-group-containing anionic polymer 6 (with a concentration of the hydrophobic-group-containing anionic polymer 6 of 12.99 percent by weight) while stirring with a stirrer, the mixture was further stirred with the stirrer for 10 minutes and subjected to ultrasonic irradiation in an ultrasonic disperser (“ULTRASONIC HOMOGENIZER UH-600S”; supplied by SMT) under ice-cooling for 40 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion F having a pigment concentration of 8 percent by weight. The dispersion F had a pigment content based on its solids content of 58.6 percent by weight.

The C/A ratio of the resulting dispersion F was determined by the procedure of Production Example 2 and found to be 1/2.0.

### Synthetic Example 9

### Synthesis of Hydrophobic-Group-Containing Cationic Polymer III: Poly(styrene-co-n-butyl acrylate-co-2-methacryloyloxyethyltrimethylammonium chloride)

A separable flask equipped with a condenser, a nitrogen inlet tube, a stirrer, and a thermometer, whose inside had been purged with nitrogen, was charged with 18.45 g of 2,2′-azobisisobutyronitrile as a catalyst. Next, the flask was further charged with 2251 g of SOLMIX A-11 (a solvent mixture of 85.5 percent by weight ethanol, 13.4 percent by weight methanol, and 1.1 percent by weight isopropyl alcohol; supplied by Japan Alcohol Trading Co., Ltd.) and 70.31 g of distilled water as solvents; 269.8 g of styrene, 249.0 g of n-butyl acrylate, and 351.5 g of ACRYESTER DMC (a 80 percent by weight aqueous solution of 2-methacryloyloxyethyltrimethylammonium chloride; supplied by Mitsubishi Rayon Co., Ltd.) as monomers; and 4.76 g of 2-mercaptoethanol as a chain-transfer agent.

The separable flask was immersed in an oil bath, the bath temperature was raised from room temperature to 78° C. over 45 minutes, and a polymerization was carried out at 78° C. for 7 hours.

After the completion of the polymerization, the reaction mixture was combined with water while removing organic solvents therefrom on an evaporator, and thereby yielded an aqueous crude polymer solution. After removing impurities from the aqueous crude polymer solution through ultrafiltration, the resulting aqueous polymer solution was concentrated and evaporated to dryness and thereby yielded a poly(styrene-co-n-butyl acrylate-co-2-methacryloyloxyethyltrimethylammonium chloride): hydrophobic-group-containing cationic polymer III.

The structure of the resulting polymer was identified through ¹H-NMR using DMSO as a solvent. The ¹H-NMR analysis revealed that the hydrophobic-group-containing cationic polymer III had a compositional ratio of styrene units to n-butyl acrylate units to 2-methacryloyloxyethyltrimethylammonium chloride units of 50:29:21 (molar ratio). The polymer was also found to have a number-average molecular weight (Mn) of 8000 and a molecular-weight distribution of 2.4 as measured through GPC.

### Production Example 9

### Preparation of Cyan Pigment Dispersion Containing Hydrophobic-Group-Containing Cationic Polymer III (Dispersion γ)

To 28.0 g of Pigment Blue-15:3 (supplied by Dainichiseika Color & Chemicals MFG. Co., Ltd.; powder; with solids content of 100.0 percent by weight) were added 86.2 g of an aqueous solution of the hydrophobic-group-containing cationic polymer III (the concentration of the hydrophobic-group-containing cationic polymer III of 19.5 percent by weight) and 165.9 g of deionized water to give a mixture. The mixture was preliminarily dispersed in a homomixer for 10 minutes and further dispersed in a self-made bead mill with zirconia beads 0.5 mm in diameter as media at 25° C. for 2 hours, from which the beads were removed, the concentration of the pigment was adjusted to 8 percent by weight, and thereby yielded a dispersion (5).

The dispersion (5) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 120 minutes, and thereby yielded a pigment dispersion (6).

The dispersion (6) was diluted 2-fold with distilled water, from which free polymers were removed through a microfilter membrane (Spectrum Laboratories Inc, made from a polysulfone, with a pore size of 0.05 μm), the filtrate was concentrated, and thereby yielded a dispersion γ having a pigment concentration of 8 percent by weight.

### Measurement of Chlorine Ion Concentration

The chlorine ion concentration of the dispersion γ was measured by the procedure of Production Example 1 and found to be 0.028 mol/L.

### Production Example 10

### Preparation of Cyan Pigment Dispersion Containing Hydrophobic-Group-Containing Cationic Polymer III and Hydrophobic-Group-Containing Anionic Polymer 6 (Dispersion G)

To 300 g of the dispersion γ was added dropwise 117.6 g of an aqueous solution of the hydrophobic-group-containing anionic polymer 6 (with a concentration of the hydrophobic-group-containing anionic polymer 6 of 12.99 percent by weight) while stirring with a stirrer, the mixture was further stirred with the stirrer for 10 minutes, and subjected to ultrasonic irradiation in an ultrasonic disperser (“ULTRASONIC HOMOGENIZER UH-600S”; supplied by SMT) under ice cooling for 75 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion G having a pigment concentration of 8 percent by weight. The dispersion G had a pigment content based on its solids content of 66.0 percent by weight.

The C/A ratio of the resulting dispersion G was determined according to the following technique and found to be 1/4.9.

### Technique for Determining C/A Ratio of Dispersion G

Copper (Cu) contents of the cyan pigment (Pigment Blue-15:3) and of the non-volatile components of the dispersion G were measured and found to be 10.8 percent by weight and 7.13 percent by weight, respectively, from which the ratio of the pigment to the polymers in the dispersion G was calculated to be 66.0/34.0 (percent by weight). Independently, nitrogen contents of the hydrophobic-group-containing cationic polymer III, of the cyan pigment, and of the non-volatile components of the dispersion G were measured through organic element analysis and found to be 2.38 percent by weight, 18.79 percent by weight, and 12.60 percent by weight, respectively. Herein a value obtained by subtracting the amount of nitrogen derived from the pigment from the amount of nitrogen in the non-volatile components of the dispersion G was defined as the amount of nitrogen derived from the hydrophobic-group-containing cationic polymer III. Thus, the content of the hydrophobic-group-containing cationic polymer III in the non-volatile components of the dispersion G was calculated to be 8.2 percent by weight; and a value obtained by subtracting this value from the polymer content was defined as the content of the hydrophobic-group-containing anionic polymer 6 (i.e., 34.0 percent by weight minus 8.2 percent by weight equals 25.8 percent by weight). A C/A ratio was calculated from the abundance ratio between the hydrophobic-group-containing cationic polymer III and the hydrophobic-group-containing anionic polymer 6 using the compositional ratio of the respective polymers determined by NMR and found to be 1/4.9.

### Synthetic Example 10

### Synthesis of Hydrophobic-Group-Containing Cationic Polymer IV: Poly(styrene-co-n-butyl acrylate-co-2-methacryloyloxyethyltrimethylammonium chloride)

A separable flask equipped with a condenser, a nitrogen inlet tube, a stirrer, and a thermometer, whose inside had been purged with nitrogen, was charged with 6.92 g of 2,2′-azobisisobutyronitrile as a catalyst. Next, the flask was further charged with 1053 g of as a solvent SOLMIX A-11 (a solvent mixture of 85.5 percent by weight ethanol, 13.4 percent by weight methanol, and 1.1 percent by weight isopropyl alcohol; supplied by Japan Alcohol Trading Co., Ltd.); and 219.4 g of styrene, 202.5 g of n-butyl acrylate, and 410.1 g of ACRYESTER DMC (a 80 percent by weight aqueous solution of 2-methacryloyloxyethyltrimethylammonium chloride; supplied by Mitsubishi Rayon Co., Ltd.) as monomers.

The separable flask was immersed in an oil bath, the bath temperature was raised from room temperature to 78° C. over 45 minutes, and a polymerization was carried out at 78° C. for 7 hours.

After the completion of the polymerization, the reaction mixture was combined with water while removing organic solvents therefrom on an evaporator, and thereby yielded an aqueous crude polymer solution. After removing impurities from the aqueous crude polymer solution through ultrafiltration, the resulting aqueous polymer solution was concentrated and evaporated to dryness and thereby yielded a poly(styrene-co-n-butyl acrylate-co-2-methacryloyloxyethyltrimethylammonium chloride): hydrophobic-group-containing cationic polymer IV.

The structure of the resulting polymer was identified through ¹H-NMR using DMSO as a solvent. The ¹H-NMR analysis revealed that the hydrophobic-group-containing cationic polymer IV had a compositional ratio of styrene units to n-butyl acrylate units to 2-methacryloyloxyethyltrimethylammonium chloride units of 45:25:30 (molar ratio). The polymer was also found to have a number-average molecular weight (Mn) of 17000 and a molecular-weight distribution of 2.2 as measured through GPC.

### Production Example 11

### Preparation of Magenta Pigment Dispersion Containing Hydrophobic-Group-Containing Cationic Polymer IV (Dispersion δ)

To 103.7 g of Pigment Red-122 (supplied by Dainichiseika Color & Chemicals MFG. Co., Ltd.; paste; with a solids content of 27.0 percent by weight) were added 80.2 g of an aqueous solution of the hydrophobic-group-containing cationic polymer IV (with a concentration of the hydrophobic-group-containing cationic polymer IV of 21.0 percent by weight) and 96.1 g of deionized water to give a mixture. The mixture was preliminarily dispersed in a homomixer for 10 minutes and further dispersed in a self-made bead mill with zirconia beads 0.5 mm in diameter as media at 60° C. for 8 hours, from which the beads were removed, the concentration of the pigment was adjusted to 8 percent by weight, and thereby yielded a dispersion (7).

The dispersion (7) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 120 minutes, and thereby yielded a pigment dispersion (8).

The dispersion (8) was diluted 2-fold with distilled water, from which free polymers were removed through a microfilter membrane (Spectrum Laboratories Inc, made from a polysulfone, with a pore size of 0.05 em), the filtrate was concentrated, and thereby yielded a dispersion 6 having a pigment concentration of 8 percent by weight.

### Measurement of Chlorine Ion Concentration

The chlorine ion concentration of the dispersion δ was measured by the procedure of Production Example 1 and found to be 0.053 mol/L.

### Production Example 12

### Preparation of Magenta Pigment Dispersion Containing Hydrophobic-Group-Containing Cationic Polymer IV and Hydrophobic-Group-Containing Anionic Polymer 6 (Dispersion H)

To 256 g of the dispersion 6 was added 64 g of distilled water to give a diluted dispersion. Independently, 158.7 g of an aqueous solution of the hydrophobic-group-containing anionic polymer 6 (with a concentration of the hydrophobic-group-containing anionic polymer 6 of 12.99 percent by weight) was diluted with 25.2 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion H having a pigment concentration of 8 percent by weight. The dispersion H had a pigment content based on its solids content of 57.9 percent by weight.

The C/A ratio of the resulting dispersion H was determined by the procedure of Production Example 2 and found to be 1/6.5.

### Production Example 13

### Preparation of Hydrophobic-Group-Containing Cationic Polymer III Yellow Pigment Dispersion (Dispersion ε)

To 28.0 g of Pigment Yellow-74 (supplied by Dainichiseika Color & Chemicals MFG. Co., Ltd.; powder; with a solids content of 100.0 percent by weight) were added 86.2 g of an aqueous solution of the hydrophobic-group-containing cationic polymer III (with a concentration of the hydrophobic-group-containing cationic polymer III of 19.5 percent by weight) and 165.9 g of deionized water to give a mixture. The mixture was preliminarily dispersed in a homomixer for 10 minutes, further dispersed in a self-made bead mill with zirconia beads 0.3 mm in diameter as media at 25° C. for 16 hours, from which the beads were removed, the concentration of the pigment was adjusted to 8 percent by weight, and thereby yielded a dispersion (9).

The dispersion (9) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 120 minutes, and thereby yielded a pigment dispersion (10).

The dispersion (10) was diluted 2-fold with distilled water, from which free polymers were removed through a microfilter membrane (Spectrum Laboratories Inc, made from a polysulfone, with a pore size of 0.05 μm), the filtrate was concentrated, and thereby yielded a dispersion ε having a pigment concentration of 8 percent by weight.

### Measurement of Chlorine Ion Concentration

The chlorine ion concentration of the dispersion ε was measured by the procedure of Production Example 1 and found to be 0.049 mol/L.

### Synthetic Example 11

### Synthesis of Hydrophobic-Group-Containing Anionic Polymer 7: Poly(isobornyl acrylate-co-sodium acrylate)

A flask equipped with a condenser, a nitrogen inlet tube, a stirrer, and a thermometer, whose inside had been purged with nitrogen, was charged with 405 g of tetrahydrofuran as a solvent; and 75.5 g of isobornyl acrylate and 104.49 g of acrylic acid as monomers. The bath temperature was raised to 60° C., and 0.43 g of 2,2′-azobisisobutyronitrile as a catalyst was added, followed by carrying out a polymerization reaction for 2 hours. The bath temperature was further raised to 65° C., followed by carrying out a polymerization reaction for 2 hours. The bath temperature was further raised to 70° C., followed by carrying out a polymerization reaction for further 4 hours.

After the completion of the reaction, the reaction mixture was cooled to room temperature and added dropwise to acetonitrile to give precipitates. The precipitates were collected, dried in vacuo, and thereby yielded a crude polymer. The crude polymer was combined with ion-exchanged water, neutralized with a 5 N aqueous sodium hydroxide solution, and thereby yielded an aqueous solution. After removing impurities therefrom through microfiltration, the aqueous polymer solution was concentrated and evaporated to dryness, and thereby yielded a poly(isobornyl acrylate-co-sodium acrylate): hydrophobic-group-containing anionic polymer 7.

The structure of the resulting polymer was identified through ¹H-NMR using DMSO as a solvent. The ¹H-NMR analysis revealed that the polymer had a compositional ratio of isobornyl acrylate units to sodium acrylate units of 25/75 (molar ratio). The polymer was also found to have a number-average molecular weight (Mn) of 11000 and a molecular-weight distribution of 1.75 as determined through GPC.

### Measurement of Sodium Ion Concentration of Hydrophobic-Group-Containing Anionic Polymer 7

The sodium ion concentration of an aqueous solution percent by weight) of the hydrophobic-group-containing anionic polymer 7 was measured by the procedure of Synthetic Example 2 and found be 0.65 mol/L.

### Production Example 14

### Preparation of Yellow Pigment Dispersion Containing Hydrophobic-Group-Containing Cationic Polymer III and Hydrophobic-Group-Containing Anionic Polymer 7 (Dispersion I)

To 256 g of the dispersion E was added 64 g of distilled water to give a diluted dispersion. Independently, 158.7 g of an aqueous solution of the hydrophobic-group-containing anionic polymer 7 (with a concentration of hydrophobic-group-containing anionic polymer 7 of 12.99 percent by weight) was diluted with 25.2 g of distilled water to give a diluted aqueous solution, this was added dropwise to the diluted dispersion while stirring with a stirrer, the mixture was further stirred with the stirrer for 10 minutes and subjected to ultrasonic irradiation in an ultrasonic disperser (“ULTRASONIC HOMOGENIZER UH-600S”; supplied by SMT) under ice-cooling for 60 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion I having a pigment concentration of 8 percent by weight. The dispersion I had a pigment content based on its solids content of 58.0 percent by weight.

The C/A ratio of the resulting dispersion I was determined by the procedure of Production Example 2 and found to be 1/3.2.

### Production Example 15

### Preparation of Black Pigment Dispersion Containing Hydrophobic-Group-Containing Cationic Polymer II (Dispersion θ)

To 28.0 g of a carbon black (#990; supplied by Mitsubishi Chemical Corporation) were added 98.5 g of an aqueous solution of the hydrophobic-group-containing cationic polymer II (with a concentration of the hydrophobic-group-containing cationic polymer II of 17.1 percent by weight) and 153.5 g of deionized water to give a mixture, the mixture was preliminary dispersed in a homomixer for 60 minutes, and further dispersed in a self-made bead mill with zirconia beads 0.5 mm in diameter as media at 60° C. for 7 hours and at 40° C. for further one hour, from which the beads were removed, the concentration of the pigment was adjusted to 8 percent by weight, and thereby yielded a dispersion (11).

The dispersion (11) was placed in a 500-ml tall beaker, the beaker was immersed in iced water, the mixture therein was dispersed in an ultrasonic homogenizer (US-600T; supplied by Nihon Seiki Seisakusho Co., Ltd.; using tips 36 mm in diameter) for 60 minutes, and thereby yielded a pigment dispersion (12).

The dispersion (12) was diluted 2-fold with distilled water, from which free polymers were removed through a microfilter membrane (Spectrum Laboratories Inc, made from a polysulfone, with a pore size of 0.05 μm), the filtrate was concentrated, and thereby yielded a dispersion 0 having a pigment concentration of 8 percent by weight.

### Measurement of Chlorine Ion Concentration

The chlorine ion concentration of the dispersion θ was measured by the procedure of Production Example 1 and found to be 0.050 mol/L.

### Production Example 16

### Preparation of Black Pigment Dispersion Containing Hydrophobic-Group-Containing Cationic Polymer II and Hydrophobic-Group-Containing Anionic Polymer 6 (dispersion J)

To 20 g of the dispersion 0 was added dropwise 14.79 g of an aqueous solution of the hydrophobic-group-containing anionic polymer 6 (with a concentration of the hydrophobic-group-containing anionic polymer of 12.99 percent by weight) while stirring with a stirrer, the mixture was further stirred with the stirrer for 10 minutes and subjected to ultrasonic irradiation in an ultrasonic disperser (“ULTRASONIC HOMOGENIZER UH-600S”; supplied by SMT) under ice-cooling for 15 minutes. Next, the dispersed mixture was concentrated on a rotary evaporator, the pH thereof was adjusted to 8 with an aqueous sodium hydroxide solution, and thereby yielded a dispersion J having a pigment concentration of 8 percent by weight. The dispersion J had a pigment content based on its solids content of 37.9 percent by weight.

The C/A ratio of the resulting dispersion J was determined by the procedure of Production Example 2 and found to be 1/2.8.

### Synthetic Example 12

### Synthesis of Hydrophobic-Group-Containing Anionic Polymer 8: Poly(styrene-co-vinylpyrrolidone-co-sodium acrylate)

A flask equipped with a condenser, a nitrogen inlet tube, a stirrer, and a thermometer, whose inside had been purged with nitrogen, was charged with 1.77 g of 2,2′-azobis(2,4-dimethylvaleronitrile) as a catalyst, and the flask was further charged with 200 g of methanol as a solvent; and 50.4 g of styrene, 60.0 g of vinylpyrrolidone, and 40.0 g of acrylic acid as monomers. The bath temperature was raised from room temperature to 70° C. over 30 minute, and a polymerization reaction was carried out at 70° C. for 7 hours.

After the completion of the reaction, the reaction mixture was cooled to room temperature, 124.17 g of a 5 N aqueous sodium hydroxide solution was added with stirring, thereafter distilled water was added while removing methanol on an evaporator, and thereby yielded an aqueous crude polymer solution. After removing impurities from the aqueous crude polymer solution through ultrafiltration, the resulting aqueous polymer solution was concentrated and evaporated to dryness, and thereby yielded a poly(styrene-co-vinylpyrrolidone-co-sodium acrylate): hydrophobic-group-containing anionic polymer 8.

The structure of the resulting polymer was identified through ¹H-NMR using d-DMSO as a solvent. The ¹H-NMR analysis revealed that the polymer had a compositional ratio of styrene units to vinylpyrrolidone units to sodium acrylate units of 50/8/42 (molar ratio). The polymer was also found to have a number-average molecular weight (Mn) of 15300 and a molecular-weight distribution of 1.6 as determined by GPC.

### Measurement of Sodium Ion Concentration of Hydrophobic-Group-Containing Anionic Polymer 8

The sodium ion concentration of an aqueous solution percent by weight) of the hydrophobic-group-containing anionic polymer 8 was measured by the procedure of Synthetic Example 2 and found to be 0.73 mol/L.

### Production Example 17

### Preparation of Black Pigment Dispersion Containing Hydrophobic-Group-Containing Cationic Polymer I and Hydrophobic-Group-Containing Anionic Polymer 8 (Dispersion K)

To 70 g of the dispersion α was added 90 g of distilled water to give a diluted dispersion. Independently, 39.65 g of an aqueous solution of the hydrophobic-group-containing anionic polymer 8 (with a concentration of the hydrophobic-group-containing anionic polymer 8 of 10.82 percent by weight) was diluted with 80.35 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion K having a pigment concentration of 8 percent by weight. The dispersion K had a pigment content based on its solids content of 61.0 percent by weight.

The C/A ratio of the resulting dispersion K was determined by the procedure of Production Example 2. Since the amounts of nitrogen of the hydrophobic-group-containing cationic polymer I and of the hydrophobic-group-containing anionic polymer 8 were 3.43 percent by weight and 1.12 percent by weight, respectively, the C/A ratio was calculated to be 1/2.2.

### Example 1

### Preparation of Recording Liquid (Ink Composition)

An ink was prepared according to the following formulation.

### Dispersion A: 6.75 g

Distilled water: 4.87 g

### Glycerol: 0.86 g

Triethylene glycol: 0.72 g

### 2-Pyrrolidone: 0.33 g

Ethylene urea: 1.32 g
OLFINE E1010 (a surfactant supplied by Air Products and Chemicals Inc.): 0.15 g

These components were mixed, stirred for 15 minutes, subjected to an ultrasonic dispersing process for 30 minutes, and thereby yielded a recording liquid according to Example 1.

Properties (a) to (e) below were evaluated on the recording liquid according to Example 1 by the following testing methods.

An ink-jet recording printer (BJ-S700 Printer; Canon Kabushiki Kaisha) was used as a printer, and a commercially available glossy paper (Glossy Paper SP-101; supplied by Canon Kabushiki Kaisha) was used as a printing paper.

### a) Particle Diameter of Dispersed Pigment

The recording liquid according to Example 1 was diluted 1000-fold with distilled water, and particle diameters of the pigment were measured using the FPAR-1000 system (Otsuka Electronics Co., Ltd.) equipped with a probe for dilute system, and an average particle diameter of dispersed particles of the pigment was calculated according to the Cumulant method.

### b) Viscosity

A viscosity of the recording liquid according to Example 1 was measured with a rheometer (REOLOGICA AB Insturuments; VAR-100; using a cone with an angle of 1° and diameter of 55), and a value at a shear rate of 100 per second was read out as the viscosity.

### c) Stability

After holding the recording liquid according to Example at 70° C. for 15 hours, the particle diameters of the dispersed pigment and the viscosity of the recording liquid were measured by the procedures of the methods a) and b). The smaller the increase of the particle diameter of the dispersed pigment, or the smaller the increase of the viscosity, the more stable the recording liquid is.

### d) Discharge Stability

The recording liquid according to Example 1 was loaded in a cartridge, and printing was conducted on 50 plies of a print paper according to a plain paper printing mode, whether thin spots (fading) and other failures occurred or not was visually observed, and the discharge stability was evaluated according to the following criteria:

Good: No fading occurs
Fair: Fading occurs during printing
Failure: It is difficult to print a clear image

### e) Gloss of Print (Record)

The glossy paper used as the printing paper, on which printing with the recording liquid according to Example 1 had been conducted, was dried at room temperature for one day, and the gloss thereof was measured. The measurement of the gloss was carried out using a Haze-Gloss Meter (supplied by BYK Gardner; Cat. No. 4601) at 20°.

### Examples 2 to 5

Recording liquids according to Examples 2, 3, 4, and 5 were prepared as inks of the formulation as in Example 1, except for using, instead of the dispersion A, the dispersions B, C, D, and E, respectively.

On the recording liquids according to Examples 2 to 5, the properties a) to e) were evaluated by the procedures of Example 1, and the results are shown in Table 1.

### Example 6

### Preparation of Recording Liquid (Ink Composition)

An ink was prepared according to the following formulation:

### Dispersion F: 5.63 g

Distilled water: 5.99 g

### Glycerol: 0.86 g

Triethylene glycol: 0.72 g

### 2-Pyrrolidone: 0.33 g

Ethylene urea: 1.32 g
OLFINE E1010 (a surfactant supplied by Air Products and Chemicals Inc.): 0.15 g

These components were mixed, stirred for 15 minutes, subjected to an ultrasonic dispersing process for 30 minutes, and thereby yielded a recording liquid according to Example 6.

On the recording liquid according to Example 6, the properties a) to e) were evaluated by the procedures of Example 1, and the results are shown in Table 1.

### Example 7

### Preparation of Recording Liquid (Ink Composition)

An ink was prepared according to the following formulation:

### Dispersion G: 5.63 g

Distilled water: 6.60 g

### Glycerol: 1.13 g

### 2-Pyrrolidone: 0.77 g

### 1,6-Hexanediol: 0.74 g

OLFINE E1010 (a surfactant supplied by Air Products and Chemicals Inc.): 0.15 g

These components were mixed, stirred for 15 minutes, subjected to an ultrasonic dispersing process for 30 minutes, and thereby yielded a recording liquid according to Example 7.

On the recording liquid according to Example 7, the properties a) to e) were evaluated by the procedures of Example 1, and the results are shown in Table 1.

### Examples 8 and 9

Recording liquids according to Examples 8 and 9 were prepared as inks of the formulation as in Example 7, except for using, instead of the dispersion G, the dispersions H and I, respectively.

On the recording liquids according to Examples 8 and 9, the properties a) to e) were evaluated by the procedures of Example 1, and the results are shown in Table 1.

### Example 10

A recording liquid according to Example 10 was prepared as an ink of the formulation as in Example 1, except for using, instead of the dispersion A, the dispersion J.

On the recording liquid according to Example 10, the properties a) to e) were evaluated by the procedures of Example 1, and the results are shown in Table 1.

### Example 11

A recording liquid according to Example 11 was prepared as an ink of the formulation as in Example 1, except for using, instead of the dispersion A, the dispersion K.

On the recording liquid according to Example 11, the properties a) to e) were evaluated by the procedures of Example 1, and the results are shown in Table 1.

### Production Example 18

### Preparation of Black Pigment Dispersion Containing Hydrophobic-Group-Containing Cationic Polymer I and Hydrophobic-Group-Containing Anionic Polymer 2 (Dispersion L)

To 70 g of the dispersion α was added 90 g of distilled water to give a diluted dispersion. Independently, 8.78 g of an aqueous solution of the hydrophobic-group-containing anionic polymer 2 (with a concentration of the hydrophobic-group-containing anionic polymer 2 of 10.54 percent by weight) was diluted with 111.22 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion L having a pigment concentration of 8 percent by weight. The dispersion L had a pigment content based on its solids content of 78.0 percent by weight.

The C/A ratio of the resulting dispersion L was determined by the procedure of Production Example 2 and found to be 1/0.7.

### Production Example 19

### Preparation of Black Pigment Dispersion Containing Hydrophobic-Group-Containing Cationic Polymer I and Anionic Polymer Containing No Hydrophobic Monomer Structural Unit (Dispersion M)

To 70 g of the dispersion α was added 90 g of distilled water to give a diluted dispersion. Independently, 8.75 g of an aqueous solution (22.40 percent by weight) of a sodium polyacrylate (supplied by Wako Pure Chemical Industries, Ltd.: Mn=25000) was diluted with 111.25 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion M having a pigment concentration of 8 percent by weight. The dispersion M had a pigment content based on its solids content of 71.1 percent by weight.

The C/A ratio of the resulting dispersion M was determined by the procedure of Production Example 2 and found to be 1/2.7.

### Synthetic Example 13

### Synthesis of Hydrophobic-Group-Containing Anionic Polymer 9: Poly(styrene-co-n-butyl acrylate-co-sodium acrylate)

A flask equipped with a condenser, a nitrogen inlet tube, a stirrer, and a thermometer, whose inside had been purged with nitrogen, was charged with 30 g of 2,2′-asobis(2,4-dimethylvaleronitrile) as a catalyst, and the flask was further charged with 3500.0 g of tetrahydrofuran as a solvent; and 600.0 g of acrylic acid, 600.0 g of n-butyl acrylate, and 400.0 g of styrene as monomers. The bath temperature was raised from room temperature to 70° C. over one hour, and a polymerization reaction was carried out at 70° C. for 8 hours.

After the completion of the reaction, the reaction mixture was cooled to room temperature, neutralized with a solution of sodium hydroxide in methanol, and precipitated in isopropyl alcohol. The precipitates were filtered, dried in vacuo, and thereby yielded a mixture of a poly(styrene-co-n-butyl acrylate-co-sodium acrylate) and sodium acrylate.

After dissolving 30.0 g of the mixture of the poly(styrene-co-n-butyl acrylate-co-sodium acrylate) and sodium acrylate in 970.0 g of water, sodium acrylate was removed from the solution through ultrafiltration. The aqueous polymer solution, from which sodium acrylate had been removed, was concentrated and evaporated to dryness, and thereby yielded a poly(styrene-co-n-butyl acrylate-co-sodium acrylate): hydrophobic-group-containing anionic polymer 9.

The structure of the resulting hydrophobic-group-containing anionic polymer 9 was identified through H-NMR using heavy water (deuterium oxide) as a solvent. The compositional ratio of sodium acrylate units to n-butyl acrylate units to styrene units in the polymer was determined through H-NMR and found to be 47:21:32 (molar ratio). The polymer was found to have a number-average molecular weight (Mn) of 11000 and a molecular-weight distribution of 1.6 as determined through GPC.

### Measurement of Sodium Ion Concentration of Hydrophobic-Group-Containing Anionic Polymer 9

The sodium ion concentration of an aqueous solution percent by weight) of the hydrophobic-group-containing anionic polymer 9 was measured by the procedure of Synthetic Example 2 and found to be 0.73 mol/L.

### Production Example 20

### Preparation of Black Pigment Dispersion Containing Hydrophobic-Group-Containing Cationic Polymer I and Hydrophobic-Group-Containing Anionic Polymer 9 (Dispersion N)

To 70 g of the dispersion α was added 90 g of distilled water to give a diluted dispersion. Independently, 38.29 g of an aqueous solution of the hydrophobic-group-containing anionic polymer 9 (with a concentration of the hydrophobic-group-containing anionic polymer 9 of 22.56 percent by weight) was diluted with 81.71 g of distilled water to give a diluted aqueous solution, this was added dropwise to the diluted dispersion while stirring with a stirrer, the mixture was further stirred with the stirrer for 10 minutes, subjected to ultrasonic irradiation in an ultrasonic cleaner (BRANSONIC 5510J-DTH) for 30 minutes, and further subjected to ultrasonic irradiation in an ultrasonic disperser (“ULTRASONIC HOMOGENIZER UH-600S”; supplied by SMT) under ice-cooling for 30 minutes. Next, unnecessary components in the aqueous phase, such as free random copolymers and excess ions, were removed through a microfilter membrane (microza; supplied by Asahi Kasei Chemicals Corporation; made from a polysulfone, with a pore size of 0.1 μm), the filtrate was concentrated, the pH thereof was adjusted to 8 with an aqueous sodium hydroxide solution, and thereby yielded a dispersion N having a pigment concentration of 8 percent by weight. The dispersion N had a pigment content based on its solids content of 45.6 percent by weight.

The C/A ratio of the resulting dispersion N was determined by the procedure of Production Example 2 and found to be 1/5.1.

### Comparative Examples 1 to 3

Recording liquids according to Comparative Examples 1, 2, and 3 were prepared as inks of the formulation as in Example 1, except for using, instead of the dispersion A, the dispersions L, M, and N, respectively.

On the recording liquids according to Comparative Examples 1 to 3, the properties a) to e) were evaluated by the procedures of Example 1, where only the properties a) to d) were evaluated on the recording liquids according to Comparative Examples 1 and 2. The results are shown in Table 1.

TABLE 1

| | Pigment dispersion containing | Pigment dispersion | | | |
|---|---|---|---|---|---|
| | hydrophobic-group-containing | containing | | | Content of |
| | cationic polymer and | hydrophobic-group- | Hydrophobic- | | pigment |
| | hydrophobic-group-containing | containing cationic | group-containing | | (percent by |
| | anionic polymer | polymer | anionic polymer | C/A ratio | weight) |
| Example 1 | A | α | 1 | 1/3.6 | 61.7 |
| Example 2 | B | α | 2 | 1/2.8 | 66.1 |
| Example 3 | C | α | 3 | 1/4.5 | 66.7 |
| Example 4 | D | α | 4 | 1/3.0 | 62.3 |
| Example 5 | E | α | 5 | 1/4.0 | 75.5 |
| Example 6 | F | β | 6 | 1/2.0 | 58.6 |
| Example 7 | G | γ | 6 | 1/4.9 | 66.0 |
| Example 8 | H | δ | 6 | 1/6.5 | 57.9 |
| Example 9 | I | ε | 7 | 1/3.2 | 58.0 |
| Example 10 | J | θ | 6 | 1/2.8 | 37.9 |
| Example 11 | K | α | 8 | 1/2.2 | 61.0 |
| Comparative | L | α | 2 | 1/0.7 | 78.0 |
| Example 1 | | | | | |
| Comparative | M | α | (Sodium | 1/2.7 | 71.1 |
| Example 2 | | | polyacrylate) | | |
| Comparative | N | α | 9 | 1/5.1 | 45.6 |
| Example 3 | | | | | |

| | Recording liquid | | | | | |
|---|---|---|---|---|---|---|
| | (initial properties) | | Stability of recording liquid | | | |
| | Particle diameter of | | Particle diameter of | | Discharge | Gloss of |
| | dispersed pigment | Viscosity | dispersed pigment | Viscosity | stability | record |
| Example 1 | 99 nm | 2.8 cp | 92 nm | 2.2 cp | Good | 92 |
| Example 2 | 104 nm | 3.2 cp | 92 nm | 2.6 cp | Good | 90 |
| Example 3 | 102 nm | 2.8 cp | 98 nm | 2.3 cp | Good | 67 |
| Example 4 | 104 nm | 2.5 cp | 98 nm | 2.2 cp | Good | 72 |
| Example 5 | 99 nm | 4.2 cp | 93 nm | 3.1 cp | Good | 91 |
| Example 6 | 86 nm | 2.2 cp | 79 nm | 1.9 cp | Good | 168 |
| Example 7 | 140 nm | 3.0 cp | 138 nm | 2.0 cp | Good | 52 |
| Example 8 | 116 nm | 3.6 cp | 107 nm | 2.5 cp | Good | 95 |
| Example 9 | 93 nm | 3.0 cp | 77 nm | 2.3 cp | Good | 100 |
| Example 10 | 109 nm | 3.6 cp | 108 nm | 3.3 cp | Good | 72 |
| Example 11 | 95 nm | 3.0 cp | 90 nm | 2.5 cp | Good | 84 |
| Comparative | 38348 nm | 2.6 cp | 12960 nm | 15.6 cp | Failure | — |
| Example 1 | | | | | | |
| Comparative | 188 nm | 3.5 cp | 31830 nm | 1044 cp | Failure | — |
| Example 2 | | | | | | |
| Comparative | 100 nm | 3.0 cp | 102 nm | 2.7 cp | Fair | 52 |
| Example 3 | | | | | | |

Table 1 demonstrates the followings.

Comparative Example 1 is an example which uses the same hydrophobic-group-containing cationic polymer and hydrophobic-group-containing anionic polymer as Example 2 but has a C/A ratio out of a suitable range. The recording liquid according to Comparative Example 1 has a very large particle diameter of the dispersed pigment, lacks stability, and is difficult to be discharged using a printer.

Comparative Example 2 is an example which uses the same cationic-group-containing cationic polymer as Examples 1 to 5, has a C/A ratio within a suitable range, but uses an anionic polymer containing no hydrophobic monomer structural unit. The recording liquid according to Comparative Example 2 has inferior stability and is difficult to be discharged using a printer.

Comparative Example 3 is an example which uses the same cationic-group-containing cationic polymer as Examples 1 to 5, but has a molar ratio of the hydrophobic monomer structural units to the anionic monomer structural units in the hydrophobic-group-containing anionic polymer being out of the range from 5/95 to 50/50, and has a pigment content in the aqueous pigment dispersion based on the solids content being less than 51 percent by weight. The recording liquid according to Comparative Example 3 lacks discharge stability, and a record obtained therefrom is inferior to any of those of Examples 1 to 5.

In contrast, the recording liquids according to Examples 1 to 11 show good stability and satisfactory discharge stability and, in addition, give records with superior gloss.

These results clearly demonstrate that the aqueous pigment dispersions according to the present invention not only show good dispersion stability of the pigment, but also give recording liquids with good discharge properties, and, in addition, give prints with superior gloss.

While the present invention has been shown and described in detail with reference to specific embodiments thereof, it will be understood by those skilled in the art that various changes and modifications may be made without departing from the spirit and scope of the present invention.

The present application is based on Japanese patent application (Japanese Patent Application No. 2007-45773) filed on Feb. 26, 2007, the entire contents of which being incorporated herein by reference.

1. An aqueous pigment dispersion comprising:
a pigment;
a hydrophobic-group-containing cationic polymer containing structural units of a cationic monomer and structural units of a hydrophobic monomer; and
a hydrophobic-group-containing anionic polymer containing structural units of an anionic monomer and structural units of a hydrophobic monomer, wherein the ratio of the number of anionic groups contained in the hydrophobic-group-containing anionic polymer to the number of cationic groups contained in the hydrophobic-group-containing cationic polymer is 1.0 or more and 8 or less, and wherein the hydrophobic-group-containing anionic polymer has a molar ratio of the hydrophobic monomer structural units to the anionic monomer structural units of from 5/95 to 50/50.

2. An aqueous pigment dispersion comprising:
a pigment;
a hydrophobic-group-containing cationic polymer containing structural units of a cationic monomer and structural units of a hydrophobic monomer; and
a hydrophobic-group-containing anionic polymer containing structural units of an anionic monomer and structural units of a hydrophobic monomer, wherein the ratio of the number of anionic groups contained in the hydrophobic-group-containing anionic polymer to the number of cationic groups contained in the hydrophobic-group-containing cationic polymer is 1.0 or more and 8 or less, and wherein the content of the pigment is 51 percent by weight or more based on the solids content of the aqueous pigment dispersion.

3. The aqueous pigment dispersion according to claim 1, which has a pH of 7 or more and 9 or less.

4. The aqueous pigment dispersion according to claim 1, wherein the pigment, if existing alone, does not disperse in water.

5. The aqueous pigment dispersion according to claim 1, wherein the hydrophobic-group-containing cationic polymer has a molar ratio of the hydrophobic monomer structural units to the cationic monomer structural units of from 40/60 to 90/10.

6. The aqueous pigment dispersion according to claim 1, wherein at least one of the hydrophobic monomer structural units in the hydrophobic-group-containing cationic polymer is a structural unit derived from an aromatic hydrocarbon.

7. The aqueous pigment dispersion according to claim 1, wherein at least one of the hydrophobic monomer structural units in the hydrophobic-group-containing cationic polymer is a structural unit derived from an aliphatic hydrocarbon having 4 or more and 12 or less carbon atoms.

8. The aqueous pigment dispersion according to claim 1, wherein the cationic monomer structural units in the hydrophobic-group-containing cationic polymer comprise a structure of a quaternary ammonium salt.

9. The aqueous pigment dispersion according to claim 1, wherein the hydrophobic-group-containing cationic polymer has a number-average molecular weight of 500 or more and 50000 or less.

10. The aqueous pigment dispersion according to claim 1, wherein the hydrophobic monomer structural units in the hydrophobic-group-containing anionic polymer comprise one or more structural units selected from the group consisting of structural units derived from aromatic hydrocarbons and structural units derived from alicyclic hydrocarbons.

11. The aqueous pigment dispersion according to claim 1, wherein the anionic monomer structural units in the hydrophobic-group-containing anionic polymer comprise one or more structures selected from the group consisting of a carboxylic acid, an alkali metal salt of a carboxylic acid, and an alkaline earth metal salt of a carboxylic acid.

12. The aqueous pigment dispersion according to claim 11, wherein the carboxylic acid and/or a salt thereof contained in the anionic monomer structural unit in the hydrophobic-group-containing anionic polymer is a carboxylic acid selected from the group consisting of acrylic acid, methacrylic acid, itaconic acid, maleic acid, and fumaric acid; and/or a salt of the carboxylic acid.

13. The aqueous pigment dispersion according to claim 1, wherein the hydrophobic-group-containing anionic polymer has a number-average molecular weight of 2000 or more and 50000 or less.

14. The aqueous pigment dispersion according to claim 1, wherein the hydrophobic-group-containing anionic polymer further contains structural units of a nonionic hydrophilic monomer in addition to the hydrophobic monomer structural units and anionic monomer structural units.

15. A method for producing the aqueous pigment dispersion of claim 1, the method comprising dispersing a pigment by the action of a hydrophobic-group-containing cationic polymer; removing an excess of the polymer from the dispersion through ultrafiltration and/or microfiltration; and subsequently adding a hydrophobic-group-containing anionic polymer.

16. A recording liquid comprising the aqueous pigment dispersion of claim 1.

17. An ink-jet recording liquid comprising the aqueous pigment dispersion of claim 1.

18. The aqueous pigment dispersion according to claim 2, which has a pH of 7 or more and 9 or less.

19. The aqueous pigment dispersion according to claim 2, wherein the pigment, if existing alone, does not disperse in water.

20. The aqueous pigment dispersion according to claim 2, wherein the hydrophobic-group-containing cationic polymer has a molar ratio of the hydrophobic monomer structural units to the cationic monomer structural units of from 40/60 to 90/10.

21. The aqueous pigment dispersion according to claim 2, wherein at least one of the hydrophobic monomer structural units in the hydrophobic-group-containing cationic polymer is a structural unit derived from an aromatic hydrocarbon.

22. The aqueous pigment dispersion according to claim 2, wherein at least one of the hydrophobic monomer structural units in the hydrophobic-group-containing cationic polymer is a structural unit derived from an aliphatic hydrocarbon having 4 or more and 12 or less carbon atoms.

23. The aqueous pigment dispersion according to claim 2, wherein the cationic monomer structural units in the hydrophobic-group-containing cationic polymer comprise a structure of a quaternary ammonium salt.

24. The aqueous pigment dispersion according to claim 2, wherein the hydrophobic-group-containing cationic polymer has a number-average molecular weight of 500 or more and 50000 or less.

25. The aqueous pigment dispersion according to claim 2, wherein the hydrophobic monomer structural units in the hydrophobic-group-containing anionic polymer comprise one or more structural units selected from the group consisting of structural units derived from aromatic hydrocarbons and structural units derived from alicyclic hydrocarbons.

26. The aqueous pigment dispersion according to claim 2, wherein the anionic monomer structural units in the hydrophobic-group-containing anionic polymer comprise one or more structures selected from the group consisting of a carboxylic acid, an alkali metal salt of a carboxylic acid, and an alkaline earth metal salt of a carboxylic acid.

27. The aqueous pigment dispersion according to claim 26, wherein the carboxylic acid and/or a salt thereof contained in the anionic monomer structural unit in the hydrophobic-group-containing anionic polymer is a carboxylic acid selected from the group consisting of acrylic acid, methacrylic acid, itaconic acid, maleic acid, and fumaric acid; and/or a salt of the carboxylic acid.

28. The aqueous pigment dispersion according to claim 2, wherein the hydrophobic-group-containing anionic polymer has a number-average molecular weight of 2000 or more and 50000 or less.

29. The aqueous pigment dispersion according to claim 2, wherein the hydrophobic-group-containing anionic polymer further contains structural units of a nonionic hydrophilic monomer in addition to the hydrophobic monomer structural units and anionic monomer structural units.

30. A method for producing the aqueous pigment dispersion of lain 2, the method comprising dispersing a pigment by the action of a hydrophobic-group-containing cationic polymer; removing an excess of the polymer from the dispersion through ultrafiltration and/or microfiltration; and subsequently adding a hydrophobic-group-containing anionic polymer.

31. A recording liquid comprising the aqueous pigment dispersion of claim 2.

32. An ink-jet recording liquid comprising the aqueous pigment dispersion of claim 2.
